(19) United States
(12) Patent Application Publication
(10) Pub. No.: US 2017/0248271 A1
(43) Pub. Date: Aug. 31, 2017

(54) FLUID SUPPLY APPARATUS

(71) Applicant: NEVALEAK HOLDINGS LIMITED, Auckland (NZ)

(72) Inventor: Bradley Alexander Slee, Auckland (NZ)

(21) Appl. No.: 15/515,819

(22) PCT Filed: Sep. 30, 2015
(86) PCT No.: PCT/IB2015/057467

§ 371 Date: Mar. 30, 2017

(30) Foreign Application Priority Data
Sep. 30, 2014 (NZ) 700550

(51) Int. Cl. F16N 21/04; F16N 21/02

(52) U.S. Cl. CPC F16N 21/04; F16N 21/02

(57) ABSTRACT

An apparatus comprising a fluid fitting such as a grease nipple, which is attachable to a device that requires lubrication, and a complementary coupler is provided. The fitting includes an insertable section for mating with a complementary receiving portion on the coupler. The fitting includes one or more first entry ports through a side of the insertable section of the fitting, and an exit distal to the insertable section. The feed channel exits of the coupler, mate with the entry ports of the fitting when the insertable section of the fitting is in a delivery position, so that a fluid can be transferred under pressure from a fluid reservoir via the coupler, into the fitting.

### FIELD OF THE INVENTION

The invention relates to the supply of fluid to a component. For example, the fluid may be a gas, or alternatively a liquid. More particularly, an aspect of the invention relates to a grease nipple and grease nipple coupler, and/or a fluid fitting and/or fluid coupler.

### BACKGROUND

The purpose of such lubrication apparatus is to provide a convenient interface between a component which requires grease to be delivered to it, such as a bearing, etc and a pressurized grease supply, sometimes called a grease gun. Common pressures utilized range from 1.7 MPa (247 psi) to 40 MPa (5800 psi), or even higher in some specialized applications (e.g. up to 10,000 PSI). The use of such high pressures implies special safety considerations and means that the grease couplers and grease fittings used in lubrication apparatuses need to be highly resilient.

In use grease fittings, such as grease nipples, are attached to the component which requires greasing. The grease nipple provides an entry point for grease into the component. A grease applicator or grease coupler which is connected to the pressurized grease supply may then be coupled with the grease nipple, in order to supply the grease to the component through the nipple.

The most common existing form of fitting used is the hardened grease nipple. The grease nipple has a hardened ball which projects from the top of the fitting, which the coupler connects to. A one-way valve is located at the end of the projecting ball to prevent grease being released from the nipple.

A variety of different forms of couplers are used to couple with the grease nipple. These couplers either force grease into the nipple under pressure alone or may also have a needle to press down on the one-way valve mechanism. In either case, the grease pressure between the coupler and the nipple generates a force pushing the coupler away from the nipple. In order to overcome this separating force couplers and nipples are typically secured to each other when in use.

One type of coupler is the clamp-style coupler which has a number of steel jaws. These jaws pass around the head of the nipple then clamp around its base and prevent the coupler and nipple from separating under pressure.

The clamp style of applicator nozzle or coupler uses a number of hardened steel jaws, usually four, built into the end of the nozzle. When the applicator is forced over the nipple these jaws are spring loaded and move out of the way and then clamp on to the base of the grease nipple. This base is often not hardened. When the grease is forced into the nipple, the jaws are forced into the base of the fitting thus preventing the nozzle from being pushed off the fitting. This clamping action can include jamming and can make it hard to remove the applicator nozzle after the grease has been injected.

The tight clamping required and movement between the coupler and the nipple can result in wear and damage to the grease nipple. The tightly clamped jaws can be hard to remove, and further damage to the nipple can occur if the coupler is forced off of the nipple.

This wear and damage to the neck and head of the nipple can cause grease to leak, and even sever the head of the nipple. The release of high-pressure grease presents a significant safety risk, and involves time and cost in replacing the fitting.

A second common type of grease coupler is the slide-on coupler. This coupler features a collar which slides (side-on) over the neck of the nipple, and prevents the collar and nipple from separating under pressure as the collar is forced up on the base of the nipple's head. The collar is dimensioned to fit over the reduced neck of the grease nipple, but to be too small to be pulled over the top of the grease nipple.

In addition to causing wear to the nipple, as already discussed in relation to the clamping-style coupler, the slide-on coupler commonly provides a poor connection with the nipple and requires space around at least one side of the equipment around the grease nipple, so that the coupler may be properly aligned and slid onto the grease nipple.

Leaking between the nipple and coupler can falsely appear to an operator to be an indication of over-pressure, and can cause the operator to stop greasing before enough grease has been supplied to the component. This can lead to unintentional wear or even the failure of the component. Further, leaked lubricant can be difficult to clean, and result in additional time to complete the lubrication task and/or result in increased downtime of the machinery.

The dangers presented by high pressure grease, particularly where nipple heads have been severed, and the pressure has been allowed to escape, are well known. Serious injuries have been documented in these situations even when operators have been wearing protective equipment.

Other problems with current lubrication apparatus include the possibility of unequal pressures forming between the grease applicator nozzle and grease fitting which can cause more wear and tear, and the possibility of unwanted entry of impurities. Additionally unequal pressure or a build up of significant back pressure in the grease line of the grease fitting, can be a problem with current lubrication apparatus. For example, high back pressures can potentially cause the applicator nozzle to break or rupture the grease nipple, and the ball bearing within the grease nipple may shoot out like a bullet, and also potentially shoot grease back onto the operator. Existing lubrication apparatus also have an excessive number of parts (eg. up to ten or more), also resulting in high maintenance, increased cost of manufacture, and increased risk of failure.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of the present invention to provide a fluid transfer apparatus and/or a lubrication apparatus and/or gas or liquid coupling apparatus, that overcomes or at least partially ameliorates some of the abovementioned disadvantages, or which at least provides the public with a useful choice.

### SUMMARY OF THE INVENTION

In one aspect the invention broadly comprises a supply apparatus which is adapted to attach to a device that requires lubrication or the supply of fluid, comprising:
a fitting, and
a complementary coupler, which is connectable to a fluid reservoir, wherein
the fitting includes an insertable section, and a fitting channel, said fitting channel having one or more entry ports through a side of the insertable section of the fitting, and a fitting exit located on an end of the fitting distal to the insertable section,
the coupler includes a body, and a hole including an inside wall, the hole being dimensioned to be a close fit over the insertable section of the fitting,
said coupler further including a feed channel with one or more feed channel exits, through the inside wall of the hole, such that when the insertable section is in a delivery position in the hole of the coupler, a fluid can be transferred under pressure from the fluid reservoir, via the feed channel, to the fitting channel, wherein said fluid is able to leave the feed channel through at least one feed channel exit and pass into the fitting channel via said one or more entry ports.

According to a further aspect the fitting channel includes at least one movable sealing means.

According to a further aspect the movable sealing means is located proximate to the or each first entry ports of the fitting channel.

According to a further aspect the sealing means is a resiliently mounted spherical ball.

According to a further aspect the fitting channel includes a first channel diameter portion leading to a second channel diameter portion, wherein the first diameter portions less than the second portion, defining a valve seat, and
the spherical ball is located in the second diameter channel portion to biasedly seal against said valve seat.

According to a further aspect the or each entry port is a hole or a slot, and has a width of 1 to 1000 μm.

According to a further aspect there are entry ports in the form of a pair of parallel slots, each of which extends across either a majority, or substantially all, of the cross-section of the insertable section of the fitting.

According to a further aspect said insertable section defines an axis of insertion, and said entry ports are located in a side wall of said insertable section and are adapted to receive fluid in a direction laterally with respect to said axis.

According to a further aspect said lateral receiving direction is perpendicular to said axis.

According to a further aspect wherein said hole of said coupler defines a second axis of insertion, and said feed channel exits are located in a side wall of said hole, and are adapted to expel fluid in a direction lateral with respect to said second axis.

According to a further aspect said lateral expelling direction is perpendicular to said second axis.

According to a further aspect said insertable section of said fitting is a frustoconical shape, and said hole of said coupler is a complimentary frustoconical shape.

According to a further aspect said frustoconical shape is tapered less than 15° from an insertion direction.

According to a further aspect insertable section is generally cylindrical in cross section, and defines an insertion direction parallel to an axis of said generally cylindrical insertable section.

According to a further aspect said one or more feed channel exits open into one or more grooves extending around the inside side wall of the coupler.

According to a further aspect there are between 1-10 feed channel exits.

According to a further aspect there are six feed channel exits.

According to a further aspect the apparatus has no additional sealing requirements, and the hole in the coupler, and the insertable section of the fitting, being dimensioned to form a fluid tight seal when engaged.

According to a further aspect the fitting includes at least one circumferential groove located around the perimeter of the insertable section, said one or more entry ports communicating with said groove and leading to the fitting channel.

According to a further aspect a further sealing means in the form of at least one continuous flexible seal is located in the circumferential groove, leaving a peripheral gap there around, and with the flexible seal being sized to allow fluid to be forced there around through the one or more entry ports.

According to a further aspect the insertable section of the fitting includes a fluid sealing means to provide a fluid tight seal between the coupler and the fitting.

According to a further aspect the fitting includes a pair of parallel, continuous fitting sealing grooves, a first fitting sealing groove and a second fitting sealing groove, around the periphery of the insertable section of the fitting, and
the first groove is above the or each entry port, and the second groove is below the or each entry port, and
within each fitting sealing groove is a continuous flexible seal which is dimensioned to form a fluid tight seal against the inside side wall of the hole of said coupler.

According to a further aspect the coupler includes a pair of parallel continuous coupler sealing grooves, including, a third coupler sealing groove and a fourth coupler sealing groove, around the inside edge of the hole, and wherein
the third groove is dimensioned so that when the coupler is in use, the third groove is above the or each entry port in the fitting, and the fourth groove is below the or each entry port of the fitting, and
within each coupler sealing groove is a continuous flexible seal which is dimensioned to form a fluid tight seal against the outside of the insertable section of the fitting.

According to a further aspect the coupler is a generally elongate body defining a coupler axis, wherein fluid flow through the body is generally parallel to said coupler axis, and
the fitting is a generally elongate body defining a fitting axis, wherein flow through the fitting body is generally parallel to said fitting axis, and
wherein during coupling, said coupler axis is coaxial with said fitting axis.

According to a further aspect the coupler is a generally elongate body defining a coupler axis, wherein fluid flow through the body is generally parallel to said coupler axis, and
the fitting is a generally elongate body defining a fitting axis, wherein flow through the fitting body is generally parallel to said fitting axis, and
wherein during coupling, said coupler axis is at an angle to said fitting axis.

According to a further aspect said angle is 90°.

According to a further aspect the hole of the coupler includes at least one vent hole providing a pathway for an unwanted fluid such as air trapped between an end of the fitting and hole, adapted to allow the air to escape there from.

According to a further aspect the pathway extends from an end of said hole to an end of the coupler.

According to a further aspect the fitting includes an insertable section coterminous with a tightening section adapted to allow said fitting to be engaged by a tool and rotated, which is in turn coterminous with a threaded section at an opposite end of the fitting to the insertable section and adapted to allow the fitting to be engaged with a machine component.

In another aspect the invention broadly comprises an apparatus including a fitting, which is attachable to a device that requires lubrication or the supply of fluid, and a complementary coupler, which is connectable to a fluid reservoir, comprising:
a fitting including an insertable section and a fitting channel, said fitting channel connecting with four entry ports opening on to a circumferential groove in an external side of the insertable section of the fitting, and a second exit through an end of the fitting distal to the insertable section,
the fitting including two sealing grooves, one on either side of the circumferential groove, each sealing groove being provided with a continuous flexible seal,
the coupler including a body and a hole including an inside wall, the hole being dimensioned to be a close fit over the insertable section of the fitting, such that the flexible seals form a tight seal against the side wall of the hole,
the coupler further includes at least two feed channels, each feed channel having one or more feed channel exits through the inside wall of the hole,
such that when the insertable section is in a delivery position in the hole, a fluid can be transferred under pressure from the fluid reservoir via the feed channel, to the fitting channel, wherein said fluid is able to leave the feed channel through at least one feed channel exit, and pass into the fitting channel via at least one said entry port.

According to a further aspect the circumferential groove may be provided with further continuous flexible seals.

According to a further aspect said insertable section defines an axis of insertion, and said entry ports are located in a side wall of said insertable section and are adapted to receive fluid in a direction laterally with respect to said axis.

According to a further aspect said lateral receiving direction is perpendicular to said axis.

According to a further aspect said hole of said coupler defines a second axis of insertion, and said feed channel exits are located in a side wall of said hole, and are adapted to expel fluid in a direction lateral with respect to said second axis.

According to a further aspect said lateral expelling direction is perpendicular to said second axis.

According to a further aspect said insertable section of said fitting is a frustoconical shape, and said hole of said coupler is a complimentary frustoconical shape.

In another aspect the invention broadly comprises a fitting, which is attachable to a device that requires lubrication or the supply of fluid, and is also attachable to a complementary coupler, which is connectable to a fluid reservoir, comprising:
the fitting including an insertable section and a fitting channel, said fitting channel having one or more entry ports through a side of the insertable section of the fitting, and a second exit through an end of the fitting distal to the insertable section;
such that when the insertable section of the fitting is in a delivery position in a hole of a coupler, a fluid can be transferred under pressure from the fluid reservoir via the fitting channel.

According to a further aspect the fitting channel includes at least one movable sealing means.

According to a further aspect the movable sealing means is located proximate to the or each entry port of the fitting channel.

According to a further aspect the sealing means is a resiliently mounted spherical ball.

According to a further aspect the fitting channel includes a first channel diameter portion leading to a second channel diameter portion, wherein the first diameter portions less than the second portion, defining a valve seat, and the spherical ball is located in the second diameter channel portion to biasedly seal against said valve seat.

According to a further aspect the or each entry port is a hole or a slot, and has a width of 1 to 1000 μm.

According to a further aspect there are entry ports in the form of a pair of parallel slots, each of which extends across either a majority, or substantially all, of the cross-section of the insertable section of the fitting.

According to a further aspect said insertable section defines an axis of insertion, and said entry ports are located in a side wall of said insertable section and are adapted to receive fluid in a direction laterally with respect to said axis.

According to a further aspect said lateral receiving direction is perpendicular to said axis.

According to a further aspect said insertable section of said fitting is a frustoconical shape, and said hole of said coupler is a complimentary frustoconical shape.

According to a further aspect said insertable section is generally cylindrical in cross section, and defines an insertion direction parallel to an axis of said generally cylindrical insertable section.

According to a further aspect the fitting includes at least one circumferential groove located around the perimeter of the insertable section, said one or more entry ports communicating with said groove and leading to the fitting channel.

According to a further aspect a further sealing means in the form of at least one continuous flexible seal is located in the circumferential groove, leaving a peripheral gap there around, and with the flexible seal being sized to allow fluid to be forced there around through the one or more entry ports.

According to a further aspect the insertable section of the fitting includes a fluid sealing means to provide a fluid tight seal between the coupler and the fitting.

According to a further aspect the fitting includes a pair of parallel, continuous fitting sealing grooves, a first fitting sealing groove and a second fitting sealing groove, around the periphery of the insertable section of the fitting, and the first groove is above the or each entry port, and the second groove is below the or each entry port, and
within each fitting sealing groove is a continuous flexible seal which is dimensioned to form a fluid tight seal against the inside side wall of the hole of said coupler.

In another aspect the invention broadly comprises an apparatus defining a coupler which is connectable to a fluid reservoir, and is connectable to a fitting, comprising:
a body including a hole having an inside wall, the hole being dimensioned to be a close fit over an insertable section of a fitting,
said coupler further including a feed channel with one or more feed channel exits through the inside wall of the hole, such that when an insertable section of a fitting is in a delivery position in the hole of the coupler, a fluid can be transferred under pressure from the fluid reservoir via the feed channel, to a fitting, and
wherein said fluid is able to leave the feed channel through at least one feed channel exit.

According to a further aspect said one or more feed channel exits open into one or more grooves extending around the inside side wall of the coupler.

According to a further aspect there are between 1-10 feed channel exits.

According to a further aspect there are six feed channel exits.

According to a further aspect the coupler includes a pair of parallel continuous coupler sealing grooves, including, a third coupler sealing groove and a fourth coupler sealing groove, around the inside edge of the hole, and wherein
the third groove is dimensioned so that when the coupler is in use, the third groove is above the or each feed channel exit, and the fourth groove is below the or each feed channel exit, and
within each coupler sealing groove is a continuous flexible seal which is dimensioned to form a fluid tight seal against the outside of the insertable section of the fitting.

According to a further aspect the coupler is a generally elongate body defining a coupler axis, wherein fluid flow through the body is generally parallel to said coupler axis, and
the fitting is a generally elongate body defining a fitting axis, wherein flow through the fitting body is generally parallel to said fitting axis, and
wherein during coupling, said coupler axis is coaxial with said fitting axis.

According to a further aspect the coupler is a generally elongate body defining a coupler axis, wherein fluid flow through the body is generally parallel to said coupler axis, and
the fitting is a generally elongate body defining a fitting axis, wherein flow through the fitting body is generally parallel to said fitting axis, and
wherein during coupling, said coupler axis is at an angle to said fitting axis.

According to a further aspect said angle is 90°.

According to a further aspect the hole of the coupler includes at least one vent hole providing a pathway for an unwanted fluid such as air trapped between an end of the fitting and hole, adapted to allow the air to escape there from.

According to a further aspect the pathway extends from an end of said hole to an end of the coupler.

According to a further aspect said hole of said coupler defines a second axis of insertion, and said feed channel exits are located in a side wall of said hole, and are adapted to expel fluid in a direction lateral with respect to said second axis.

According to a further aspect said lateral expelling direction is perpendicular to said second axis.

According to a further aspect said hole of said coupler is a frustoconical shape.

According to a further aspect said coupler has no additional sealing means within the hole in the coupler.

According to a further aspect the hole of the coupler includes at least one vent hole providing a pathway for an unwanted fluid such as air trapped between an end of the fitting and hole, adapted to allow the air to escape there from.

According to a further aspect at least one vent hole is large and/or numerous, such that a portion of said coupler upstream of said feed channel is mostly open to the atmosphere.

According to a further aspect said coupler is skeletal, and said feed channel extends through a limb of said skeletal structure.

According to a further aspect the pathway extends from an end of said hole to an end of the coupler.

In another aspect the invention broadly comprises a fitting assembly for providing gases from a gases supply, to a component to be pressurised or inflated, comprising:
an elongate valve body having a first end, and a second end, and being at least partially hollow to define a valve body wall,
valve core slidably located within the hollow valve body,
wherein the valve body includes at least one passageway within the valve body wall, and wherein said passageway begins at an entry port on an internal face of the hollow of said valve body, and at least an initial portion of said passageway extends transverse to the valve body, and terminates at an exit located a distance from the first end of said valve body,
wherein the valve core, when in a first position blocks said entry port, and when in a second position opens said entry port.

According to a further aspect said valve core is retained in said hollow of said valve body, such that it can be moved between a first position wherein said valve core is at least mostly within set valve body, and a second position wherein said valve core is entirely within said valve body.

According to a further aspect said valve core is biased towards a said first position.

According to a further aspect said valve core includes sealing means between an outer surface of said valve core, and an inner surface of said hollow of said valve body.

According to a further aspect said sealing means comprises a pair of flexible continuous seals, one of which is located above the level of said at least one entry port, and the other of said seals is located below the level of said at least one entry port.

According to a further aspect said hollow body is blocked at one end, being said second end.

According to a further aspect said valve body includes sealing means between an outer surface of said valve core and an inner surface of said hollow of said valve body.

According to a further aspect said sealing means comprises a pair of flexible continuous seals, one of which is located above the level of said at least one entry port, and the other of said seals is located below the level of said at least one entry port.

According to a further aspect said valve body is adapted to be fitted to said component to be inflated or pressurised, such that said exit communicates with said component.

In another aspect the invention broadly comprises a coupler adapted to receive a fluid from a fluid supply, and to couple with a fitting comprising:
an elongate body having a first inlet end, and a second outlet end, wherein said inlet end is adapted to receive fluid from said fluid supply, and said outlet end is adapted to couple with a fitting,
a receiving recess in said outlet end of said body defining an inner projection, and surrounding said inner projection,
a fluid supply passageway extending from said inlet through said projection, and terminating in at least one exit port in an outer wall of said projection, wherein said exit port is adapted to expel fluid in a direction transverse to an axis of said body.

According to a further aspect said transverse direction is perpendicular.

According to a further aspect said one or more exit ports open into one or more grooves extending around an outer surface of said projection.

According to a further aspect there are between 1-10 exit ports.

According to a further aspect there are 2 exit ports.

According to a further aspect the coupler includes a pair of parallel continuous coupler sealing grooves, including, a first coupler sealing groove and a second coupler sealing groove, around the outer surface of said projection, and wherein the first groove is located above the exit ports, and the second groove is below the exit ports, and
within each coupler sealing groove is a continuous flexible seal.

According to a further aspect said receiving recess in said outlet end of said body further defines an outer wall extending around said receiving recess.

According to a further aspect said outer wall projects beyond an outermost extent of said projection.

In another aspect the invention broadly comprises a fluid transfer apparatus comprising:
a fitting according to any one of the above clauses, and
a coupler according to any one of the above clauses.

According to a further aspect when in an engaged position, said exit port is able to communicate with said entry port.

In another aspect the invention broadly comprises a nipple for passing grease to a component to be lubricated, and which, when in use, is also attachable to a coupler which is connected to a grease supply, the nipple comprising:
a first end to be attached to the component to be lubricated, and a second end having an insertable section to be coupled to a grease supplying component, and a grease channel, having at least one entry port and one or more exit ports,
wherein the one or more grease channel entry ports are located on the second end of the nipple, and are transverse to a direction of coupling.

In another aspect the invention broadly comprises a coupler for providing grease from a grease supply to a grease nipple, the coupler comprising:
a first end to be attached to a grease supply under pressure, and a second end to receive and couple with a grease nipple, and
a grease channel, having one or more entry ports at the first end adjacent to the grease supply, one or more exit ports at the second end,
wherein the grease exit port is located on the inside of a receiving aperture of the second end of the coupler, and said exit port is transverse to a direction of coupling.

In another aspect the invention broadly comprises a fitting substantially as described herein, and with reference to any one or more of the drawings.

In another aspect the invention broadly comprises a coupler substantially as described herein, and with reference to any one or more of the drawings.

In another aspect the invention broadly comprises a fluid transfer apparatus substantially as described herein, and with reference to any one or more of the drawings.

In another aspect the invention broadly comprises a grease nipple substantially as herein described, and with reference to any one or more of the drawings.

In another aspect the invention broadly comprises a grease nipple coupler substantially as herein described, and with reference to any one or more of the drawings.

The invention consists in the foregoing and also envisages constructions of which the following gives examples only.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

These and other features and characteristics of the present invention, as well as the method of operation and functions of the related elements of structures and the combination of parts and economics of manufacture, will become more apparent upon consideration of the following description with reference to the accompanying drawings, all of which form part of this specification, wherein like reference numerals designate corresponding parts in the various figures.

### BRIEF DESCRIPTION OF THE DRAWINGS

FIG. 1 is a schematic cross-sectional view of a fitting and coupler, in a disconnected state.

FIG. 2 is a schematic cross-sectional view of the apparatus of FIG. 1 in a connected state with fluid being delivered through the apparatus.

FIG. 3 is a schematic cross-sectional view of an alternative fitting and coupler apparatus, in a disconnected state.

FIG. 4 is a schematic cross-sectional view of the apparatus of FIG. 3, in a connected state with fluid being delivered through the apparatus.

FIG. 5 is a schematic cross-sectional view of a further alternative fitting and coupler apparatus, in a disconnected state.

FIG. 6 is a schematic cross-sectional view of the apparatus of FIG. 5, and a connected state with fluid being delivered through the apparatus.

FIG. 7a is a schematic side view of a further alternative fitting and coupler apparatus in a disconnected state.

FIG. 7b is a schematic side view of a further alternative fitting and coupler apparatus in a disconnected state.

FIG. 8a is a schematic side view of a further alternative fitting and coupler apparatus in a disconnected state.

FIG. 8b is a schematic side view of a further alternative fitting apparatus.

FIG. 9a is a side view of a further alternative fitting.

FIG. 9b is a side view of a further alternative fitting.

FIG. 9c is a side view of a further alternative fitting.

FIG. 9d is a side view of a further alternative fitting.

FIG. 10 is a side view of a further alternative fitting.

FIG. 11a is a perspective view of an alternative fitting, shown without O-rings in position.

FIG. 11b is a cross-sectional perspective view of the fitting of FIG. 11a, shown without valving means.

FIG. 11c is a cross-sectional view of the fitting of FIG. 11a, shown with valve means.

FIG. 12 is a perspective view of a coupler.

FIG. 13 is a cross-sectional perspective view of the coupler of FIG. 12.

FIG. 14 is a cross-sectional schematic view of an alternative coupler.

FIG. 15 is a different cross-sectional schematic view of the coupler of FIG. 14.

FIG. 16 is a cross-sectional schematic view of an alternative coupler.

FIG. 17 is a cross-sectional schematic view of a alternative coupler engaged with a fitting.

FIG. 18 is a perspective view of an alternative side coupler.

FIG. 19 is a cross-sectional perspective view of the side coupler of FIG. 18.

FIG. 20 is a cross-sectional perspective view of the side coupler of FIG. 18.

FIG. 21 is a cross-sectional view of the side coupler of FIG. 18.

FIG. 22 is a perspective view of an alternative fitting.

FIG. 23 is a cross-sectional perspective view of the fitting of FIG. 22 shown without some internal components.

FIG. 24 is a cross-sectional view of the fitting of FIG. 22, shown in a closed position.

FIG. 25 is a cross-sectional view of the fitting of FIG. 24, shown in an open position.

FIG. 26 is a side view of a valve component of the fitting of FIG. 22.

FIG. 27 is a perspective view of the valve component of FIG. 26.

FIG. 28 is a cross-sectional view of the fitting of FIG. 22 shown in a disengaged, and engaged state with a coupler.

FIG. 29 as a cross-sectional view of an alternative fitting.

FIG. 30 as a cross-sectional view of an alternative coupler.

FIG. 31 is a cross-sectional view of the fitting of FIG. 29 engaged with a coupler of FIG. 30.

FIG. 32 is a cross-sectional view of the fitting of FIG. 29 partially disengaged with a couple of FIG. 30.

### DETAILED DESCRIPTION

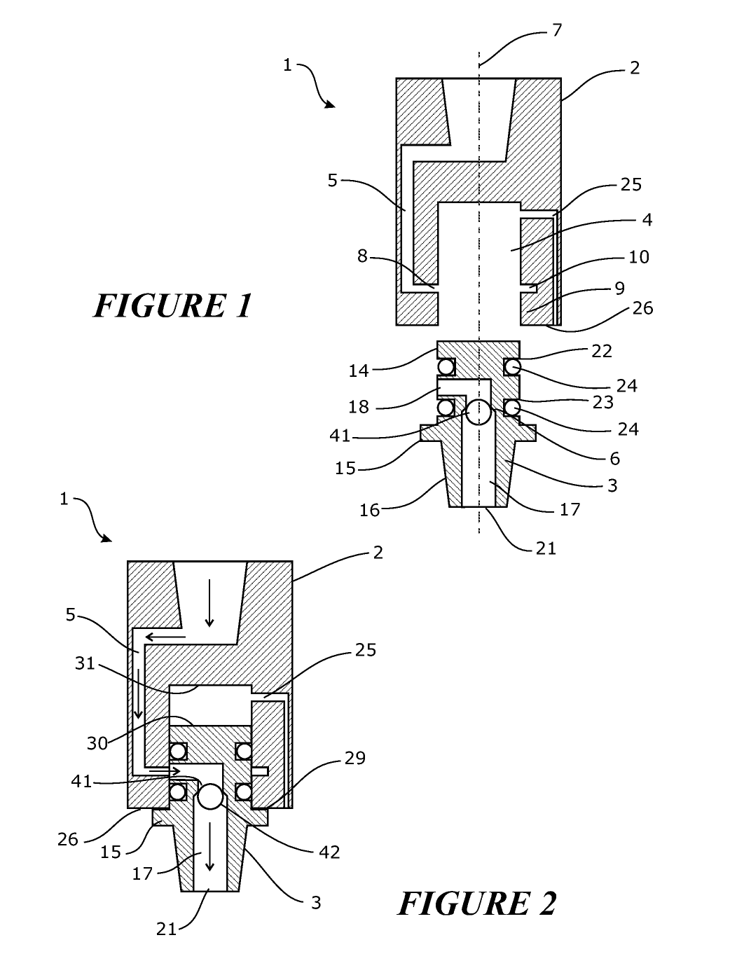

Referring to FIG. 1 of the drawings, a first embodiment of a lubrication apparatus 1 is shown schematically. The apparatus 1 is described as a lubrication apparatus for convenience. It will be appreciated that the apparatus is also suitable for transfer of other fluids, being gas, liquid and/or gels.

The apparatus 1 comprising an applicator nozzle or coupler 2 adapted to provide a source of lubricant, and a fitting 3 adapted to receive the lubricant to provide to a device where required. The coupler 2 can be provided as part of a grease gun connectable to a fluid reservoir, and the fitting 3 can be provided by a grease nipple type arrangement.

Referring to FIG. 1, the applicator nozzle or coupler 2 includes a blind hole 4 defining a side wall 9, and an internal feed channel 5. The feed channel 5 having one or more feed channel exits 8 through the inner side wall 9 of the coupler 2. The feed channel 5 provides a path for the grease to flow from a grease delivery system (not shown), to one or more feed channel exits 8. The feed channel exit 8 in this embodiment is a continuous groove 10 that extends around an internal circumference of the wall 9. Alternatively, multiple feed channel exits 8 (e.g. approximately 1 to 10), may be provided. In one preferred configuration, six exits 8 are provided spaced radially around the wall 9, each feeding into slot 10, extending around at least part of the circumference of coupler 2.

The fitting 3 includes, at one end, an insertable section which includes cylindrical section 14, coterminous with a tightening section 15, which is in turn coterminous with a threaded section 16 located at the other end.

Wholly within the fitting 3 is a fitting channel 17, this fitting channel 17 has one or more entry ports 18 through the side of the cylindrical section 14 of the fitting 3, and an exit 21 through an end of the fitting 3 distal to the cylindrical section 14. The or each entry port 18 may be a hole (of circular or other cross-section) of approximately 1 to 1000 μm in width, or may be slots, functioning as an entry for the grease sourced from the exit 8 of the coupler 2.

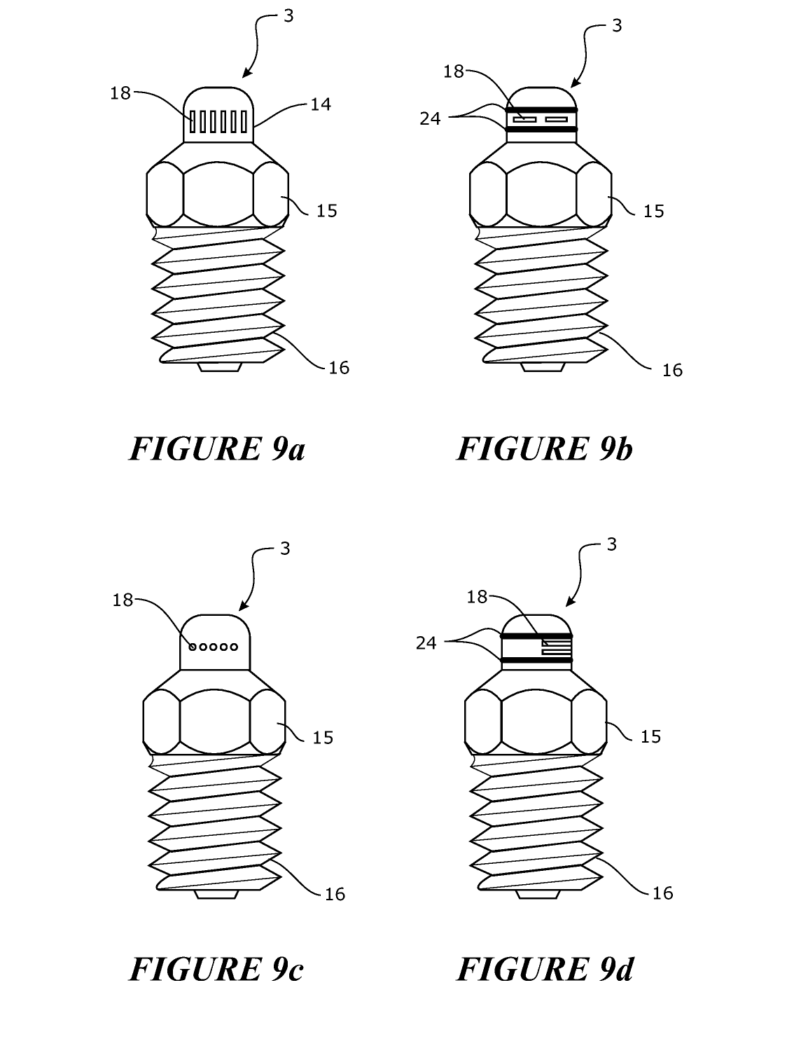

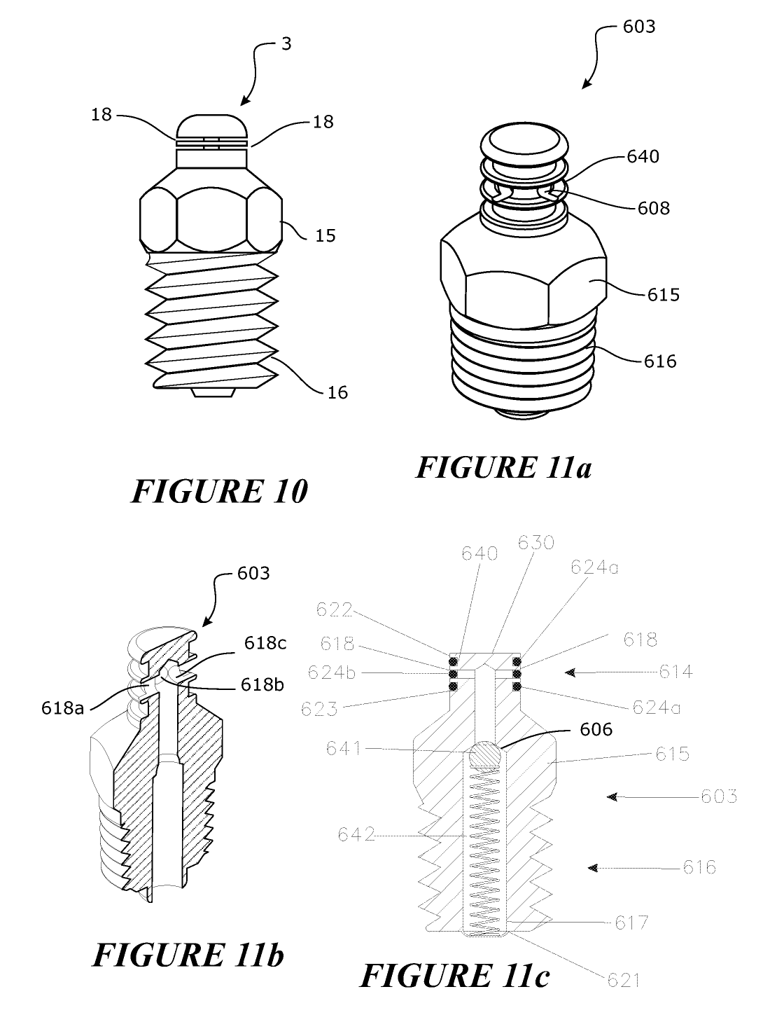

Some alternative examples of different configurations of entry ports 18 are shown in FIGS. 9a-9d, and FIG. 10. FIG. 10 shows an alternative preferred embodiment in which two entry ports 18 are provided in the form of parallel slots, each of which extends across substantially the entire cross-section of the cylindrical section 14, except for the necessary pillars within each slot 18, required to maintain the structural integrity of the fitting 3. These can may ideally be formed by laser cutting of the cylindrical section.

Referring back to FIG. 1, the cylindrical section 14 is dimensioned to be a close fit inside the blind hole 4 in the coupler 2, although the top and bottom corners of the fitting 3 to and coupler 2 respectively, may be rounded somewhat to help with alignment during coupling (not shown in FIGS. 1 to 6).

Inside fitting channel 17 there is a sealing means 41. In this example the sealing means 41 is a spherical ball retained and operated as a seal in a standard manner known in the art. E.g: with a ball bearing movably held by a spring (not shown) in a large diameter channel 17 leading to a narrower diameter entrance portion, defining a seat 6.

The threaded section 16 engages with a matching threaded hole (not shown) in the device (not shown) to be supplied with grease. The threaded section 16 connecting and, when tightened correctly, providing a fluid tight seal between the fitting 3, and the device (not shown).

The tightening section 15 is hexagonal in cross section when viewed along the centreline of the fitting 3, and preferably has its entire periphery outside the diameter of the cylindrical section 14, to allow easy access by a spanner. The tightening section 15 is further dimensioned to allow the force required to reversibly connect the fitting 3, to the device (not shown), to be applied without distortion or failure of the fitting 3.

Alternatively, it will be appreciated that the tightening section 15 may comprise a pair of opposed parallel flat surfaces, or any other shape suitable for mating with a spanner, or spanner like tool.

The fitting 3 further includes a first sealing groove 22, and a second sealing groove 23; the first sealing groove 22 is located above the level of each entry port 18, the second sealing groove 23 is located below the level of each entry port 18. Within each sealing groove 22, 23 is a continuous flexible sealing member, such as for example at least one O-ring or flexible gasket 24. The O-ring 24 is dimensioned to form a fluid tight seal against the side wall 9 of the coupler 2.

It will be appreciated that under pressure of fluid transferring between the coupler 2 and fitting 3 (described later), the O-rings will be pressed into a sealing state.

To assemble the lubrication apparatus 1, the blind hole 4 in coupler 2 is engaged with the cylindrical section 14 of the fitting 3. The coupler 2 is pushed on to the fitting 3 coming to rest when the coupler end 26 contacts the top face 29 of the tightening section 15.

In this engaged position, each feed channel exit 8 is aligned with the or each entry port 18, as shown in FIG. 2.

In order to facilitate engagement, it will be appreciated that blind hole 4 is shaped to substantially correspond with the shape of the insertable portion 14 of the fitting 3. In this respect, it is envisaged that a large number of possible complementary shapes may be adopted. The described embodiments disclose substantially cylindrical and/or conical shapes for convenience, although these shapes are preferred due to their circular cross sections, which suit standard circular O-rings.

However, the person skilled in the art will readily be able to adapt various shapes and provide suitable flexible gasket's to match. For example, the complementary cross-sectional shapes of the blind hole 4 and insertable portions 14 respectively, may be: oval, elliptical, polygonal (with sharp or rounded corners), star shaped (with sharp or rounded corners), Reuleaux polygons, quatrefoil, pentalobe etc.

During the engagement of the coupler 2, with the fitting 3, any fluid trapped between a top 30 of the fitting 3, and a blind end 31 of the blind hole 4, can escape via one or more vent holes 25 in the coupler 2.

The or each vent hole 25 routes the grease to an exterior surface of the coupler 2 so that any trapped fluid can vent to the atmosphere. For example, as shown in FIG. 1 the vent 25 leads to a point on the coupler end 26, and preferably there are several vent holes 25 spaced around the circumference of the blind hole 4.

The or each vent hole 25 also allows air to be sucked in during the removal of the coupler 2 from the fitting 3. Alternatively, at least one vent hole 25 may be located either in the side of the coupler 2.

In a further embodiment (described later in shown in FIG. 17) the coupler 2 and fitting 3, are dimensioned such that the coupler 2 comes to rest when the top 30 of the fitting 3 contacts the blind end 31, of the blind hole 4, and aligns the or each feed channel exit 8 with the or each entry port 18, of fitting 3.

In use, as shown in FIG. 2, the or each entry port 18 of the fitting 3, aligns with the or each feed channel exit 8 of the coupler 2, the sealing means in the form of O-rings gaskets 24 providing a fluid tight seal between the coupler 2 and the fitting 3.

It will be appreciated that groove 10 (if provided), allows the apparatus to function when the radial alignment of the exit 8, with entry port 18, is not perfect.

The grease from the grease delivery system (not shown, but including a reservoir and connected directly or indirectly, to the coupler) is pressurised and forced through the feed channel 5, and into the feed channel exit 8. The pressure of the grease increases in the feed channel exit 8 until the spherical ball 41 is moved out of the way, opening the seal, and the grease then flows through the fitting channel 17 out of the second exit 21, and into the device to be lubricated (not shown). It will be appreciated that incompressible fluids (or at least nearly incompressible) will be easily able to move the ball valve 41.

### Alternative Sealing Arrangements

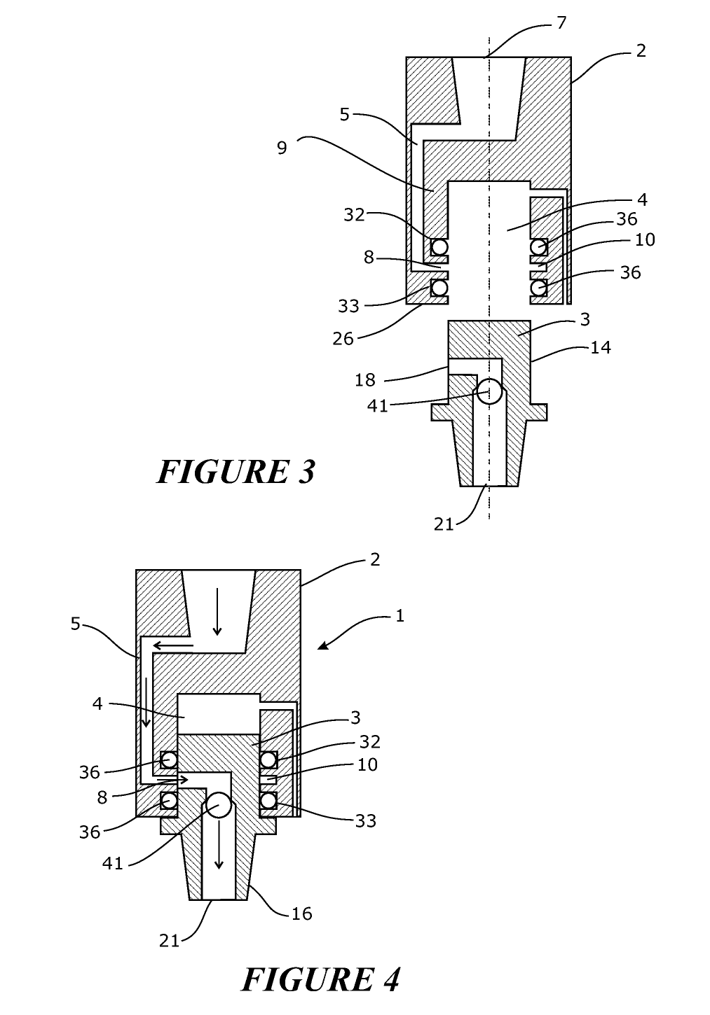

In a further alternative variation, as shown in FIG. 3 and FIG. 4, the apparatus 1 is substantially the same as that of FIG. 1 and FIG. 2 (and the reference numerals are used), except as described below:—
the cylindrical section 14 is not grooved; instead the coupler 2 includes a pair of parallel continuous nozzle sealing grooves 32,33 in the side walls 9.

A first sealing groove 32, and a second sealing groove 33, are provided around the inside circumference of the blind hole 4, perpendicular to the centreline of the blind hole 4. The sealing grooves 32,33 are located so that when the coupler 2 is in use, (as shown in FIG. 4), the first sealing groove 32 is above the or each first exit 8 in the fitting, and the second sealing groove 33 is below the or each first exit of the fitting.

Within each sealing groove 32,33 is a continuous flexible sealing member such as for example sealing means in the form of an O ring or gasket 36, which is dimensioned to form a fluid tight seal against the outside of the cylindrical section 14 of the fitting 3.

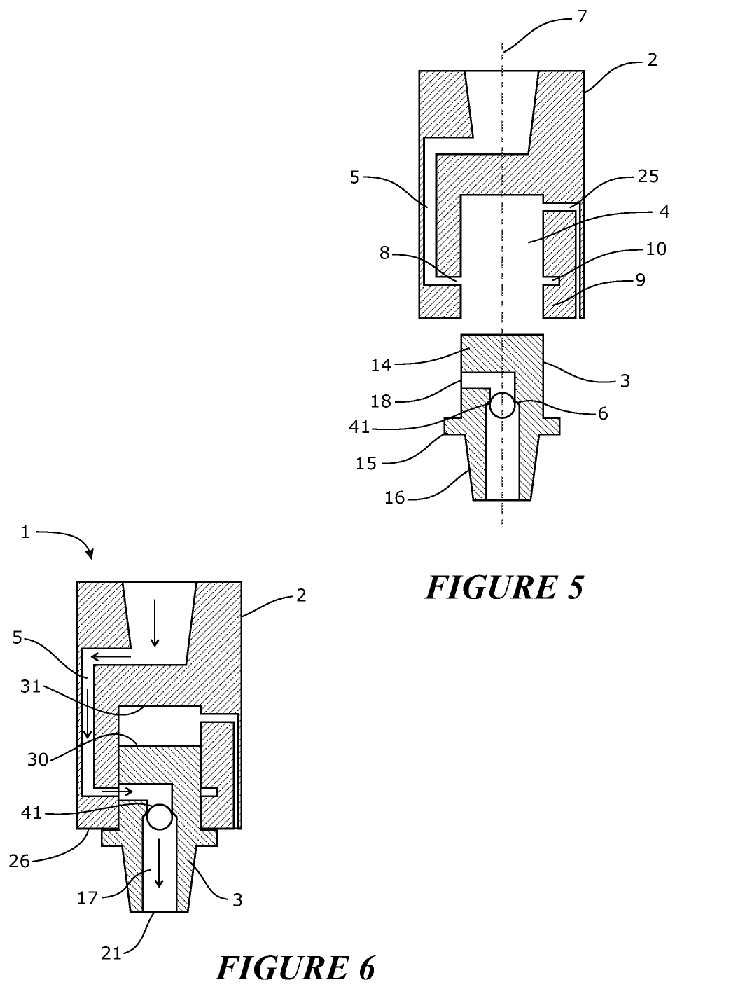

In a further alternative variation, as shown in FIG. 5 and FIG. 6, the apparatus 1 is the same as that of FIG. 1 and FIG. 2 (and the reference numerals are used), except as described below:—
the cylindrical section 14 of the fitting 3 is not grooved, and neither are the side walls 9 of the coupler 2.

This configuration requires close tolerances between the interior surface of blind hole 4 in the coupler 2, and the exterior surface of the cylindrical section 14 of the fitting 3, to form a fluid tight seal between the coupler 2, and fitting 3. This embodiment may be particularly suitable to use with for example, a ceramic coupler 2, for example, as ceramic parts can be manufactured to very close tolerances.

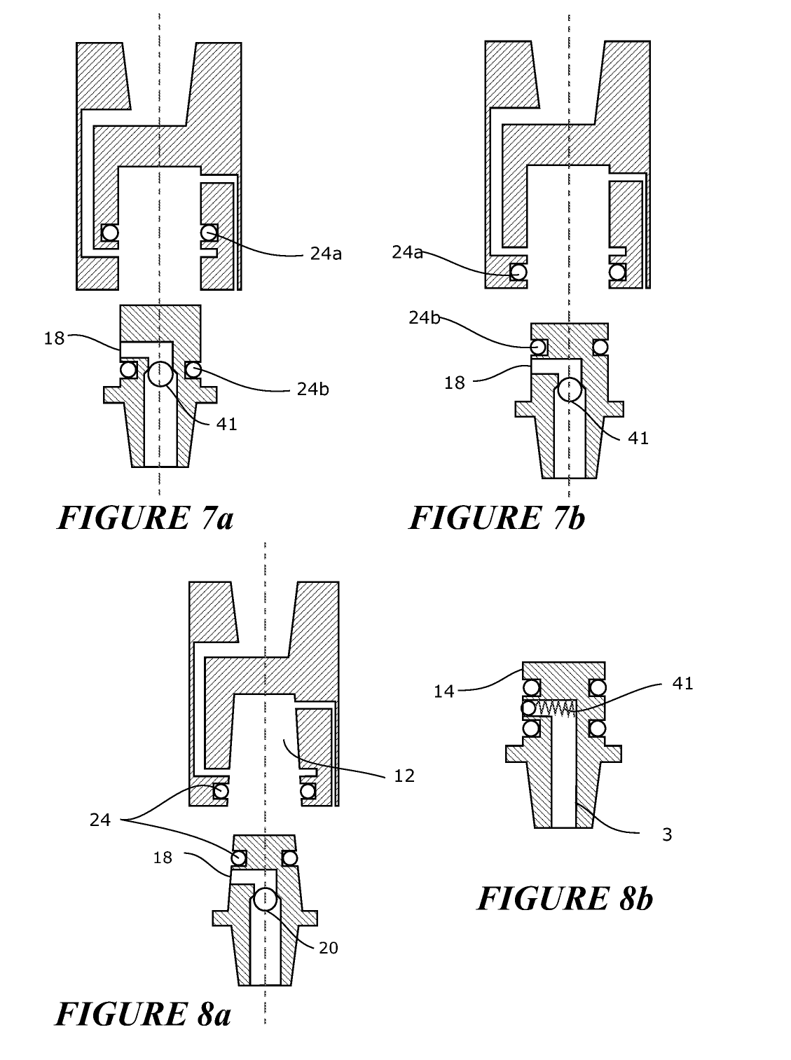

In still further alternative variations, as shown in FIGS. 7a and 7b, either of the seal above or below the entry port(s) 8, may be associated with the coupler 2, while the other of the seal (above or below the entry port(s) 8), may be associated with the fitting 3.

FIG. 7a, illustrates the upper seal (O-ring 24a) being associated with the coupler 2, and the lower seal (O-ring 24b), being associated with the fitting 3.

FIG. 7b, illustrates the upper seal (O-ring 24a) being associated with the fitting 3, and the lower seal (O-ring 24b), being associated with the coupler 2. It will be appreciated that in use, these configurations provide substantially the same result with respect to sealing performance.

FIGS. 7a and 7b illustrate this shared sealing configuration, with respect to the fitting and coupler geometry illustrated in FIGS. 1 and 2. However, similar shared seal configurations may be adopted in many other configurations, for example those illustrated in FIGS. 9 to 11, and 17 etc.

The feed channel exit 8, and entry ports 18, (or at least the terminal and initial portions thereof respectively) are oriented to be substantially perpendicular to the coupling direction 7, thereby minimising pressurised fluid forces parallel to the coupling direction, which would otherwise tend to try and separate the coupler 2 from the fitting 3.

In use, the grease flowing as shown by the arrows in FIGS. 2, 4 and 6, through the coupler 2, is fed into the side of the fitting 3 (i.e. perpendicular to the longitudinal axis 7, and coupling direction), which reduces or eliminates any forces generated by the flow of grease seeking to separate the applicator nozzle (coupler) from the fitting (i.e. parallel to the longitudinal axis 7, and coupling direction).

In particular, the coupling direction in which the insertable portion of fitting 3 couples with the coupler 2, is at least approximately perpendicular, to the direction of flow of lubricant from the coupler 2 to the fitting 3. That is, at least the terminal (last) portion of feed channel exit 8 is at least approximately perpendicular to the coupling direction, and at least the initial (first) portion of the entry port 18, is also at least approximately perpendicular to the coupling direction.

In practice, it has been found that it is not always necessary for the exit 9, or entry ports 18 to be actually geometrically perpendicular. What is important is that they mate in a generally lateral or transverse direction, so that the respective ports are located on the side of the fitting 3, and the coupler mates with the side ports so that grease is forced along the passageway, rather than against a surface causing a separation force between the coupler 2, and fitting 3.

However, alternatively the exit 9, and/or entry ports 18 may be actually geometrically perpendicular.

A further embodiment is illustrated in FIG. 8, in which the insertable portion 13 is tapered or frustoconical (rather than cylindrical). In embodiments including this feature, a complimentary coupler 2 is provided with a complimentary tapered blind hole 12.

As shown in FIG. 8, the coupler 2 includes a seal that takes up a position below entry port 18 in use, while the fitting 3 includes a seal that takes up a position above feed exit 8 in use. In alternative configurations including a tapered insertable portion 13, either the coupler 2, or fitting 3 may include both upper and lower seals as described in relation to previous embodiments.

In this embodiment, the coupling direction in which the insertable portion of fitting 3 couples with the coupler 2, is also at least approximately perpendicular, to the direction of flow of lubricant from the coupler 2 to the fitting 3. That is, at least the terminal (last) portion of feed channel exit 8 is at least approximately perpendicular to the coupling direction, and at least the initial (first) portion of the entry port 18, is also at least approximately perpendicular to the coupling direction.

Alternatively, the entry ports 18 and/or the channel exits 8 are at least lateral or transverse, to the insertion direction.

Accordingly, forces opposing the coupling direction generated by the high-pressure lubricant are still significantly reduced, because the high-pressure lubricant does not press against a large area of the tapered surface of the insertable portion 13.

In this respect, it is preferred that the taper (shown in FIG. 8b) is less than approximately 15 degrees from vertical.

In each of these embodiments, the or each entry port 18 is a substantially round hole of approximately 1 mm in diameter, and is sealed by a sealing means 41. However, it will be appreciated that the particular application for which the apparatus is used may call for smaller, or much larger apparatus. Accordingly, the above examples are typical of a ‘standard’ sized coupler 2, and fitting 3.

The sealing means 41 is preferably a movable spherical ball 41 retained and operating as a seal in a standard manner known in the art. However, it will be appreciated that other valve mechanisms may be used to allow high-pressure fluid into the fitting, while preventing egress of fluid after the filling operation is completed.

Further, it will be appreciated that the seal 41, as illustrated is only one possible example. In alternative variations, the seal 41 may be located adjacent entry port 18 as shown in FIG. 8a (rather than further down the body of fitting 3). Such configurations may have the advantage of preventing (or at least inhibiting) debris from entering the entry port 18.

Alternatively, the seal 41 is preferably located approximately as illustrated, or even further towards the lower end of fitting 3. An advantage of such a configuration is the ability to seal even if the cylindrical portion 14 is broken off fitting 3.

### Alternative Nipple Configurations

With reference to FIG. 9a-d, a non-exhaustive list of alternate configurations of entry port 18, for the grease fitting 3 are illustrated. FIG. 9a includes entry port(s) 18 as a series of the vertical slots spaced radially around insertable portion 14. Further, the upper portion of cylindrical portion 14 is rounded, in order to provide smooth entry into the hole 4 of an appropriately shaped coupler.

The alternative variation of FIG. 9b, includes a plurality of entry ports 18 as a series of horizontally spaced slots. For illustration purposes FIG. 9b also includes seals 24, as described earlier.

The further alternative variation of FIG. 9c, includes a plurality of entry ports 18 as a series of horizontally spaced holes.

The further alternative variation of FIG. 9d, includes a plurality of entry ports 18 as a series of vertically spaced slots. For illustration purposes FIG. 9d also includes seals 24, located above and below the entry ports 18, as described earlier.

It will be appreciated that the spatial arrangement and cross-sectional shape of the entry port(s) 18, and corresponding feed channel exits 8 (of the coupler 2), need not necessarily match exactly. All that is necessary is that they intersect so that the fluid can flow from at least one coupler exit 8, into at least one fitting entry port 18.

Similarly, it will be appreciated that the various combinations of seal arrangements 24 can be applied to each of the coupler 2 and/or fitting 3 shapes in a similar way as described above in order to provide:
Sealing below the entry ports 18
sealing above the entry ports 18,
sealing both above and below the entry ports 18, and
no flexible seal

As noted previously, embodiments including one or more grooves 10, allow some radial misalignment, between the coupler two and fitting 3, without significantly affecting performance.

Referring to FIGS. 11 to 17 of the drawings, further alternative embodiments of the modified lubrication apparatus 601 is shown. The apparatus 601 comprises an applicator nozzle or coupler 602 with feed channels 605, and a fitting 603.

Referring to FIG. 13, the coupler 602 includes a blind hole 604, and a plurality of internal feed channels 605 (a pair is shown), each feed channel 605 having one or more feed channel exits 608 through the side wall 609 of the coupler 602.

The feed channels 605, provide paths for the grease to flow from a grease delivery system (not shown) to one or more feed channel exits 608. Multiple feed channel exits 608 may be provided, or the feed channel exits may be linked in one or more continuous grooves around the surface of the side wall 609.

The feed channels 605, need to provide a path between the grease delivery system and the or each feed channel exits 608, but it will be apparent to one skilled in the art this may be achieved by many different configurations of feed channels 605.

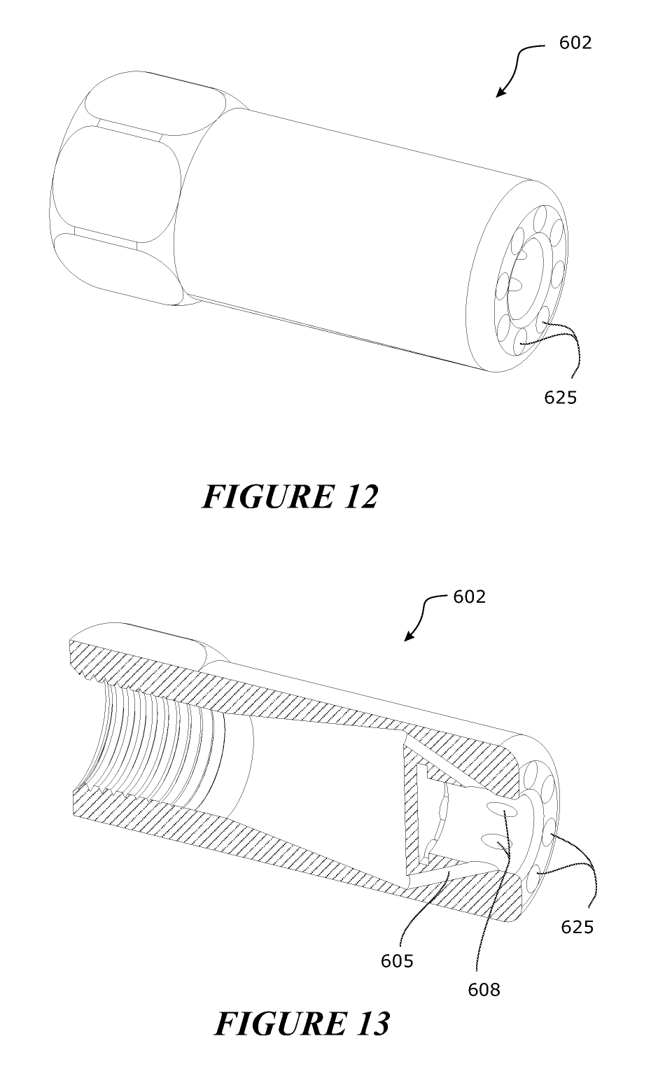

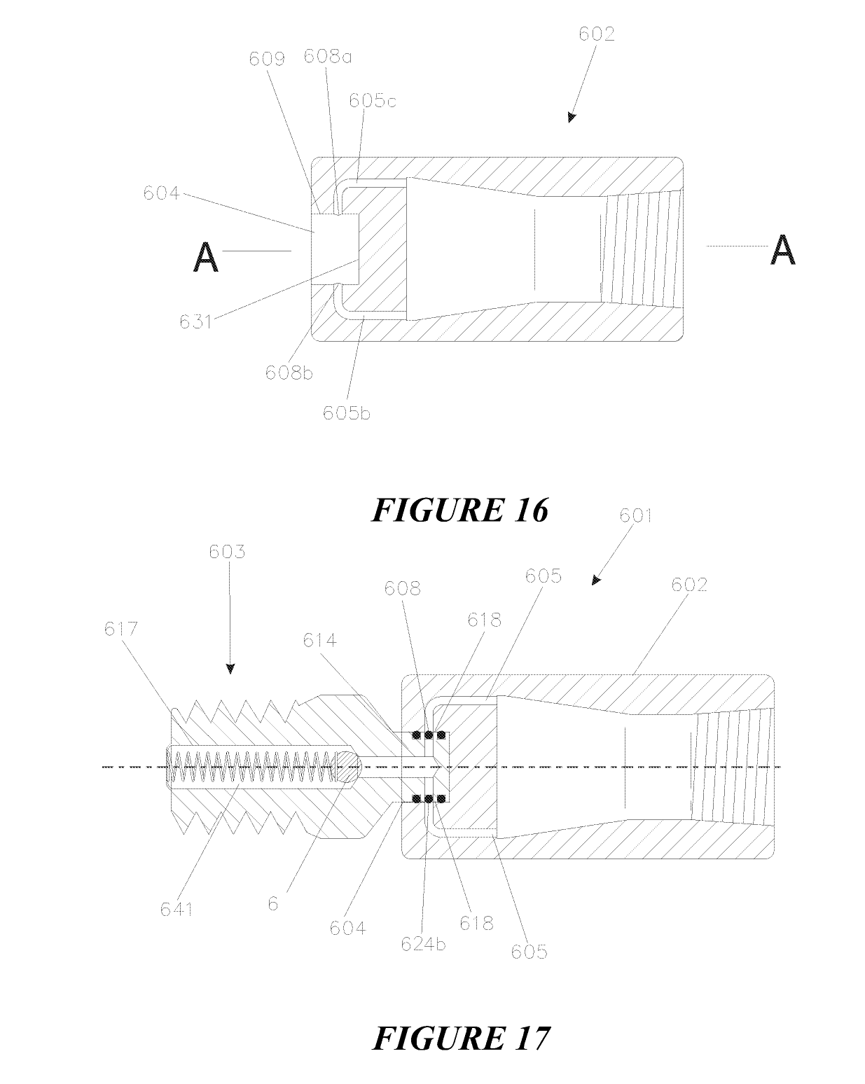

One embodiment of the feed channels 605 is shown in FIGS. 12 to 14; an alternative embodiment of the feed channels 605, is shown in FIGS. 16 to 17, but these are intended to be non-limiting examples.

The fitting 603 of FIGS. 11 and 17 includes, at one end, an insertable cylindrical section 614 coterminous with a tightening section 615, which is in turn coterminous with a threaded section 616.

Wholly within the fitting 603 is a fitting channel 617, and this fitting channel 617 has one or more entry ports 618 through the side of the cylindrical section 614 of the fitting 603, and an exit 621 through an end of the fitting 603, distal to the cylindrical section 614.

The, or each entry port 618 includes a hole (of circular or other cross-section) of 1 to 1000 μm in width, or may be vertical or horizontal slots. Examples of different configurations of entry port configurations 618 are shown in FIGS. 9a-9d.

FIG. 10 shows a further preferred embodiment in which two entry ports 618 are provided in the form of parallel slots, each of which extends across substantially the entire cross-section of the cylindrical section, (except for the necessary pillars within each slot required to maintain the structural integrity of the fitting). These may ideally be formed by laser cutting of the cylindrical section.

The entry ports 618 may be sealed by a sealing means, such as a spherical ball 641, retained by spring 642 and operating as a seal in a standard manner known in the art.

The configuration of the entry ports 618 of the fitting 603 will be complementary to the configuration of the feed channel exits 608 of the coupler 602, as described below.

In the embodiment shown in FIGS. 11a-c, fitting 603 has four entry ports 618 (only three of which are visible in the cross sectional view of FIG. 11c, being 618a, 618b, 618c), each of which opens on to a circumferential groove 640 around the cylindrical section 614.

Circumferential groove 640 may receive a continuous flexible sealing member such as for example at least one O-ring, or gasket 624b. The purpose of this O-ring 624b, is to prevent, (or at least reduce), any debris from entering the ports 618.

FIG. 12 shows an alternate embodiment of the coupler 602. FIG. 12 shows a cross-section of the coupler body 602 in which two grease flow paths 605 from the blind hole 604 are shown. These grease flow channels 605 pass through the side wall 609, and terminate at feed channel exits 608, such that grease can flow approximately perpendicular to the insertion direction 7, into the entry port 618.

In use, the fluid or grease is pushed under pressure from the feed channel exits 608 of the applicator nozzle 602, onto the O-ring located in channel or groove 640, to squeeze around a peripheral gap between the O-ring and channel 640, leading to entry port 618 located within the groove (640)

The cylindrical section 614 is dimensioned to be a close fit inside the blind hole 604 in the coupler 602. In FIG. 11, it can be seen that the top surface of the cylindrical portion 614 is chamfered or rounded in order to help with the alignment during coupling.

Inside fitting channel 617 is a sealing means 641. The sealing means 641 is a spherical ball retained and operated as a seal in a standard manner known in the art, for example, as a spring-loaded ball (by spring 642).

The fitting channel 617 includes a first channel diameter portion and second channel diameter portion, whereby the first channel diameter portion is less than the second channel diameter portion. The first channel diameter portion is located close to the entry port(s) 618, and the ball 641 is located within the second channel diameter portion to be held against a seat portion 606, to seal the fitting channel unless grease is forced there against the ball 641.

The threaded section 616 engages with a matching threaded hole (not shown) in the device (not shown) to be supplied with grease. The threaded section 616 connecting and, when tightened correctly, providing a fluid tight seal between the fitting 603, and the device (not shown).

The tightening section 615 is hexagonal in cross section when viewed along the centreline of the fitting 603, and is dimensioned to allow the force required to reversibly connect the fitting 603 to the device (not shown), to be applied without distortion or failure of the fitting 603.

As seen FIG. 13 the fitting 603 further includes a first sealing groove 622 and a second sealing groove 623; the first sealing groove 622 is located above the or each entry port 618, the second sealing groove 623 is located below the or each entry port 618. Within each sealing groove 622, 623 is a continuous flexible sealing member such as for example at least one O-ring or flexible gasket 624a, which is dimensioned to form a fluid tight seal against the side wall 609, of the blind hole 604 in the coupler 602.

To assemble the apparatus 601, the blind hole 604 in the coupler 602 is engaged with the cylindrical section 614 of the fitting 603. The coupler 602 is then pushed on to the fitting 603, coming to rest when the top 630, of the fitting 603, contacts the blind end 631 of the blind hole 604. In this engaged position, the or each feed channel exit 608, is aligned with the or each entry port 618.

During the engagement of the coupler 602, with the fitting 603 any fluid trapped between the top 630, of the fitting 603, and a blind end 631 of the blind hole 604, can escape via one or more vent holes 625, in the coupler 602, as shown in FIG. 15.

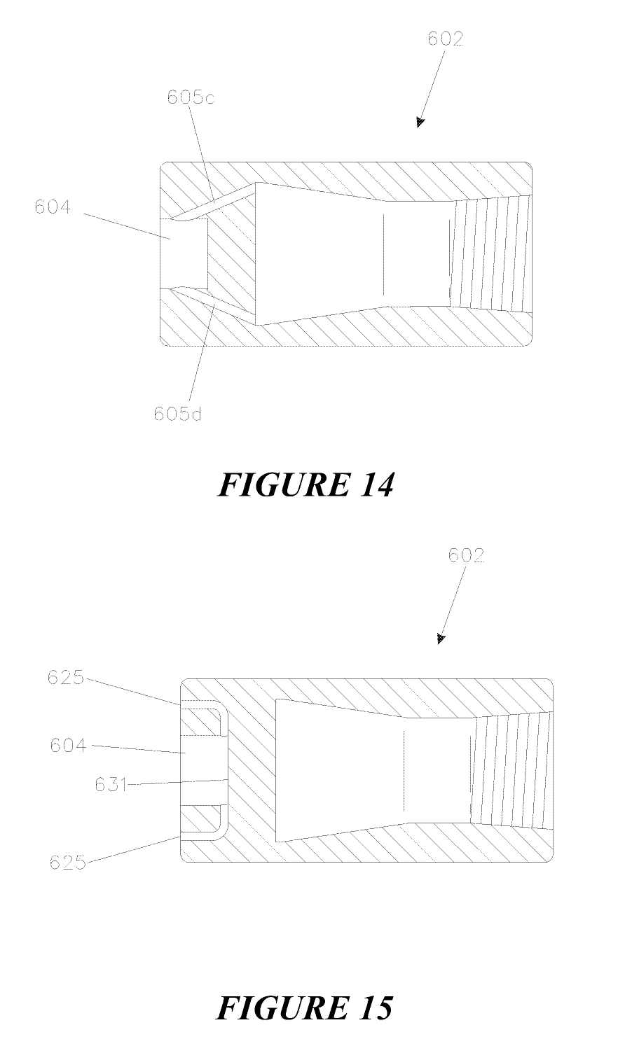

The FIG. 15 view is a sectional view that is sectioned orthogonal to the section on FIG. 14, and so does not show the feed channels 605. The, or each vent hole 625 routes the fluid to a point on the end of the coupler 602. Preferably there are several vent holes 625 spaced around the circumference of the blind hole 604. The, or each vent hole 625, also allows air to be sucked in, (or pushed out) during the removal (or insertion) of the coupler 602 from the fitting 603. Alternatively, at least one vent hole 625 may be located in the side of the coupler 602.

Ready for use, as shown in FIG. 17, the or each entry port 618, aligns with the or each feed channel exit 608, the sealing member e.g. O-ring or gasket 624a, providing a fluid tight seal between the coupler 602, and the fitting 603.

The grease from the grease delivery system (not shown, but including a reservoir and connected directly, or indirectly, to the coupler) will be pressurised and forced through the feed channel 605, and into the feed channel exit 608. The grease will be passed around the edges of the O-ring 624b, and into channel 640, before entering entry ports 618. The pressure of the grease will increase in the feed channel exit 608, until the spherical ball 641 is moved out of the way, opening the sealing means and allowing grease past ball 641. Grease can flow through the fitting channel 617, out of exit 621, and into the device to be lubricated (not shown).

The various embodiments described above include a number of different features, and it will be apparent to one skilled in the art that they may be combined in combinations other than those specifically described, in order to achieve the object of the invention, and without departing from the spirit and scope of the present invention. All such modifications and variations as would be apparent to persons skilled in the art fall within the broad scope and ambit of the invention.

### Advantages

a) fewer parts or components
b) simple manufacture
c) easy on and easy off
d) no teeth or jaws in the coupler
e) single part for the coupler
f) modest cost
g) low or no risk of jamming
h) low risk of grease leakage during transfer
i) less wear and tear
j) less risk of impurities entry
k) equalized pressure
l) sealed joint
m) easy to operate
n) able to vent unwanted air
o) less likely to get nipple break-off
p) side entry for grease from grease nozzle
q) side entry for grease into grease fitting/nipple

### Variations

The tightening section 15, 615, and threaded section 16,616 can be as long, or have a pitch as required. Similarly for the coupler 2, 602 this can be as long as necessary and have an outer tightening portion to allow a fastening tool to rotate the coupler 2, 602 onto whatever it is to fluidly connected to eg an applicator or grease gun or a fluid line etc.

The number of outlets for vent holes 25,625 can be any number, pattern and diameter and be placed wherever required. The number, size and spacing of the grooves 22,23, 622, 623, 32, 33 can be varied to suit requirements and similarly for the gasket 24, 624 which can be placed on the fitting 2, and/or in the blind hole 4. The size and shape of the feed channel 5 can also be varied.

It will also be understood that where a product, method or process as herein described or claimed and that is sold incomplete, as individual components, or as a “kit of Parts”, that such exploitation will fall within the ambit of the invention.

In yet further options the fitting 3 can also include a dust cover member (not shown), like for example being in the form of a cylindrical member having an internal recess portion shaped to mirror the outward shape of the insertable section 14, and optionally extend to cover the tightening section (15). In this example the dust cover can be made of plastics or silicon.

### Side Coupler

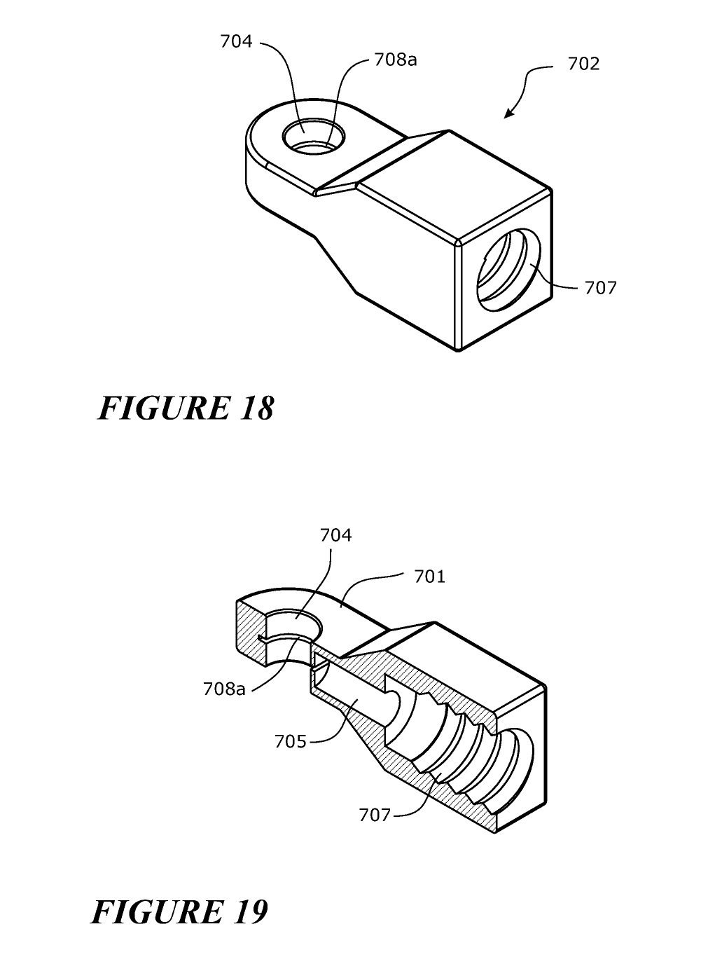

FIGS. 18-21 show another embodiment of the coupler 702, which is shaped and adapted to allow the coupler 702 to be oriented in a substantially horizontal plane with regard to the fitting (not shown). However, it will still be appreciated that the insertion direction of the coupler 702 over the cylindrical portion 14, is essentially the same as described previously. This embodiment allows access to the fitting 3, in situations where a direct axial approach may be hindered.

The fluid supply end is provided with means to allow removable connection to a supply of lubricant or whatever fluid is being used by the apparatus. In this example the means includes a cylindrical recess 707 with a peripheral inner thread. The main body of the coupler 702, is a substantially square shaped cross-section, with a flat end face at the discharge end 701.

A grease feed channel 705 extends through the body of the coupler from the grease supply 707, to the grease channel exit 708. In this embodiment the receiving portion 704 of the coupler 702, extends entirely through the body of the coupler, thus eliminating the need for vent passages to allow trapped air to escape. Further, this embodiment may allow the coupler 702 to be fitted to a fitting from either side. Alternatively, the nipple receiving portion 704 may be a blind hole, as described previously.

In use, the insertable portion of a grease nipple 14 may be inserted into the receiving portion 704. Grease may be then passed from the grease supply, through the grease channel 705, and out the grease channel exit 708, wherein it passes into the inlet ports 18, of the grease nipple fitting 3. It will be appreciated that the feed channel exit ports 708, may be complimentary shaped, to operate with any of the grease nipple fittings 3 described in this specification.

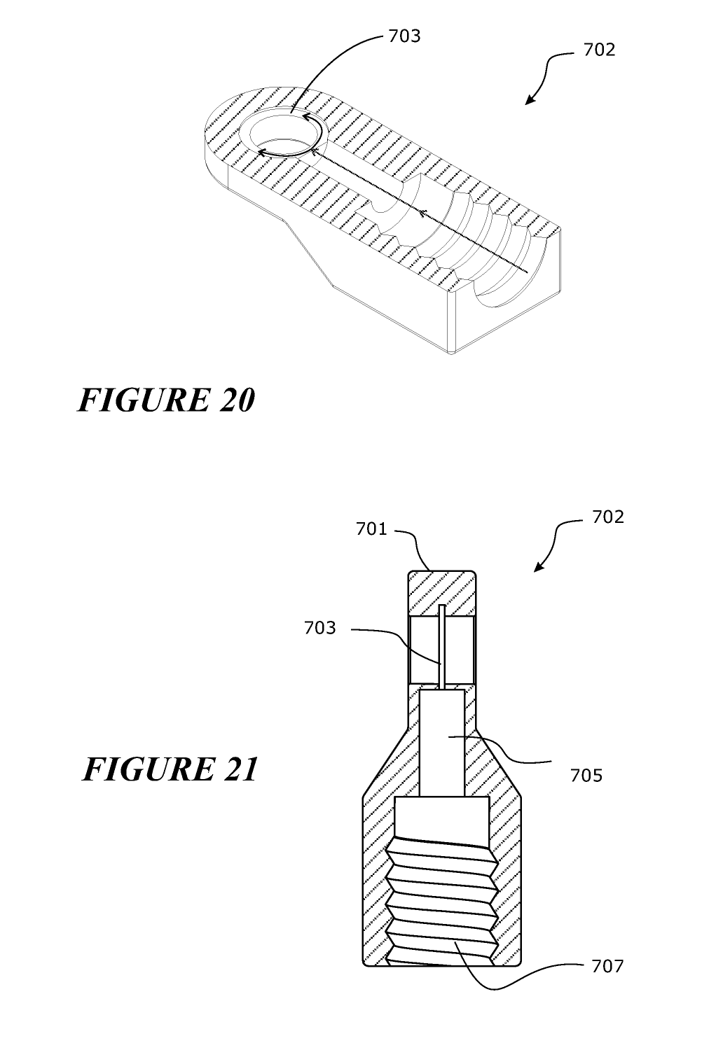

The outlet port 708 of the grease channel of the coupler 702 may consist of a circumferential ring 703 around the nipple receiving portion 704. This arrangement allows grease to pass to the inlet port 18 of the nipple regardless of the circumferential orientation of the receiving inlet ports on the nipple (as shown by arrows in FIG. 20).

### Pneumatic Valve

An additional alternate embodiment of a coupling apparatus 800, that is particularly suited for gases transfer, comprises a coupler 802, and fitting 803. For convenience, these embodiments described below will be referred to generally as a pneumatic coupling apparatus, comprising a pneumatic fitting and a pneumatic coupler, however it will be appreciated that such apparatus may also find use in the transfer of other gases, and/or fluids.

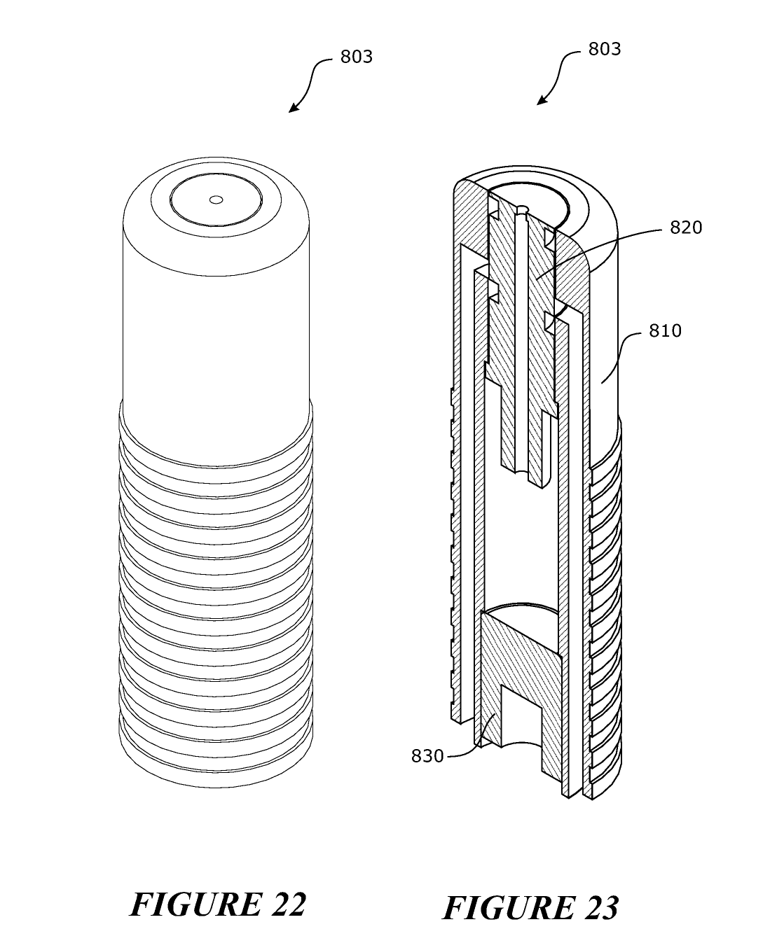

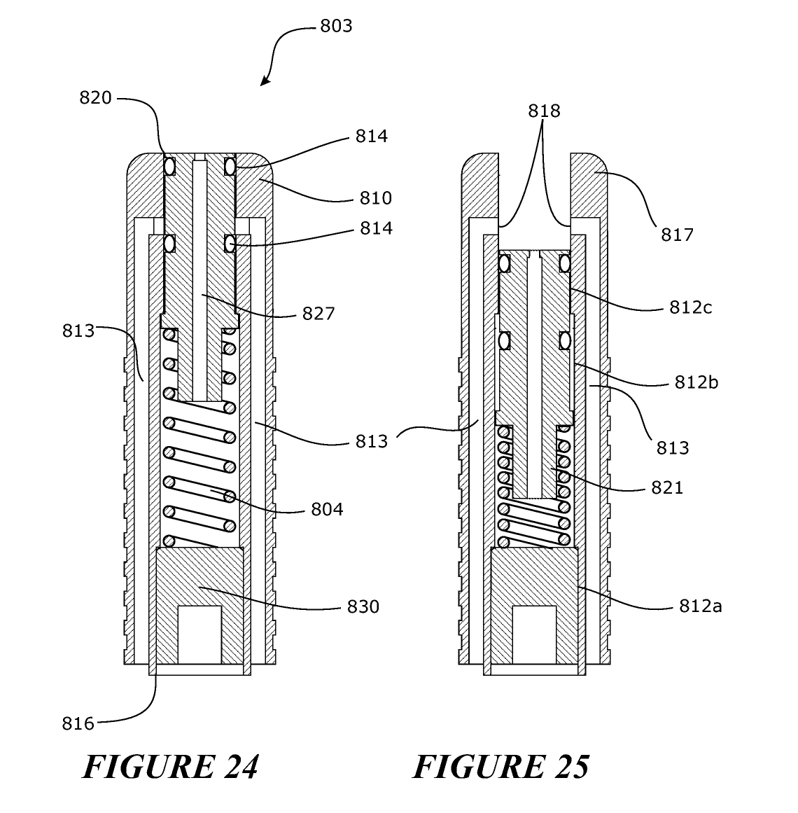

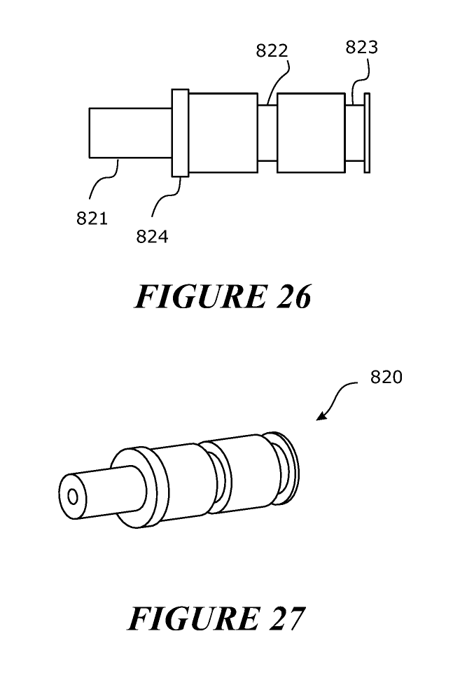

The pneumatic coupling apparatus 800, and operation of the apparatus 800, is illustrated in FIGS. 22-29.

The pneumatic fitting assembly 803 comprises an elongate hollow body 810, valve core 820 and a valve base 830. The fitting 803 comprises a hollow body with a first end 816 which is adapted to be connected to a component to be inflated or pressurized (not shown), and a second coupling end 817, which is adapted to be connected to the coupler 902 (described in more detail later).

It is envisaged that this coupling apparatus is particularly suited to applications where a component needs to be charged or filled, such as (but not limited to) pneumatic tyres, refrigeration systems etc.

The hollow body 810 preferably has three stepped internal diameters 812a, 812b and 812c, where each successive portion is of a smaller diameter, for receiving and retaining the valve core 820 within.

One or more air channels 813 are located in the wall of body 810. An inlet end of the air channels 813 are fluidly connected to inlet ports 818. The other (outlet) end of the one or more air channels 813, terminate in the component to be inflated or pressurised such that pressurised gases flowing through channels 813 can flow into the component.

The air valve core 820 is located within the hollow section 812. The core 820 preferably has a generally cylindrical shape with a lower end 821 of a smaller diameter, to allow spring 84 to pass around the lower end 821. Additionally the core 820 has one or more grooves 822, 823 in it to accommodate one or more sealing gaskets, such as o-rings 814.

A pressure relief channel 827 may additionally be located through (e.g. through the centre) the air valve core 820. The pressure relief channel 827 can allow gasses from below the air valve core 820, in the hollow sections 812b and 812c, to escape as the valve core slides downwards.

Core 820 preferably includes a shoulder 824 of a larger diameter, provided to contact the interface between the two hollow body parts 812b and 812c. This feature provides a positive stop, retaining the valve core 820 within the body 810.

The valve base 830 is dimensioned to fit snugly inside the widest part 812a of the hollow valve body 812, and retains the valve core 820 and spring 804 assembly within the valve body 810.

The assembly 803 includes a spring 804 (or other biasing means) located between the valve base 830, and the valve core 820. The spring 804 biases the valve core 820 into an upper (closed) position, to ensure the entry ports 818 are sealed, thereby preventing pressurized air in the component to be pressurised and or inflated from escaping.

As illustrated particularly in FIG. 25, when air is to be passed to the component to be inflated or pressurized, the valve core 820 must be displaced downwards, to unseal the entry ports 818, thereby allow high-pressure fluid to be forced into channels 813.

In order to displace the valve core 820 downwards (and preferably provide a seal to the end 817 of the valve), fitting assembly 803 is coupled with a specially adapted coupler 902.

The air coupler 902 has a first end which is connected to the air valve assembly and a second end which is to be connected to the pressurized air supply (not shown).

The first end of the air coupler 902 which is able to be connected to the air valve assembly 803 has a projection 901 from its centre. The projection is sized to fit snugly into the narrowest hollow portion 812c of the air valve body 810, to displace the air valve core 820 downwards.

An external wall or hollow shell of material 907 preferably extends around the outside of the first end of the air coupler 902, defining a receiving area 904. The receiving area 904 is sized to snugly receive the end 817 of the air valve body 810.

In some configurations, the wall 907 may extend below the extent of projection 901. In this way the coupler 902 can be aligned onto the end of fitting 803, prior to the projection 901 engaging the valve core 820. This feature protects the projection 901 and/or valve core 820 from damage during alignment.

In a further variation, the wall 907 (or body of fitting 810), may be provided with features to provide a friction fit. Preferably, a friction fit is sufficient to resist the coupler 902 and fitting 803 from being pushed apart by the force of spring 804. For example the features may be surface textures, coatings or o-rings, or any other suitable method.

Within the air coupler 902 is an air delivery channel 905. The air channel 905 extends from the end connected to the pressurized air supply, through the projection 901. The air channel 905 terminates in one or more outlet ports 908, located on the sidewalls of the projection 901. The terminal portion of the outlet ports 908 are transverse to the direction in which the air coupler 902, and air valve assembly 803 couple together.

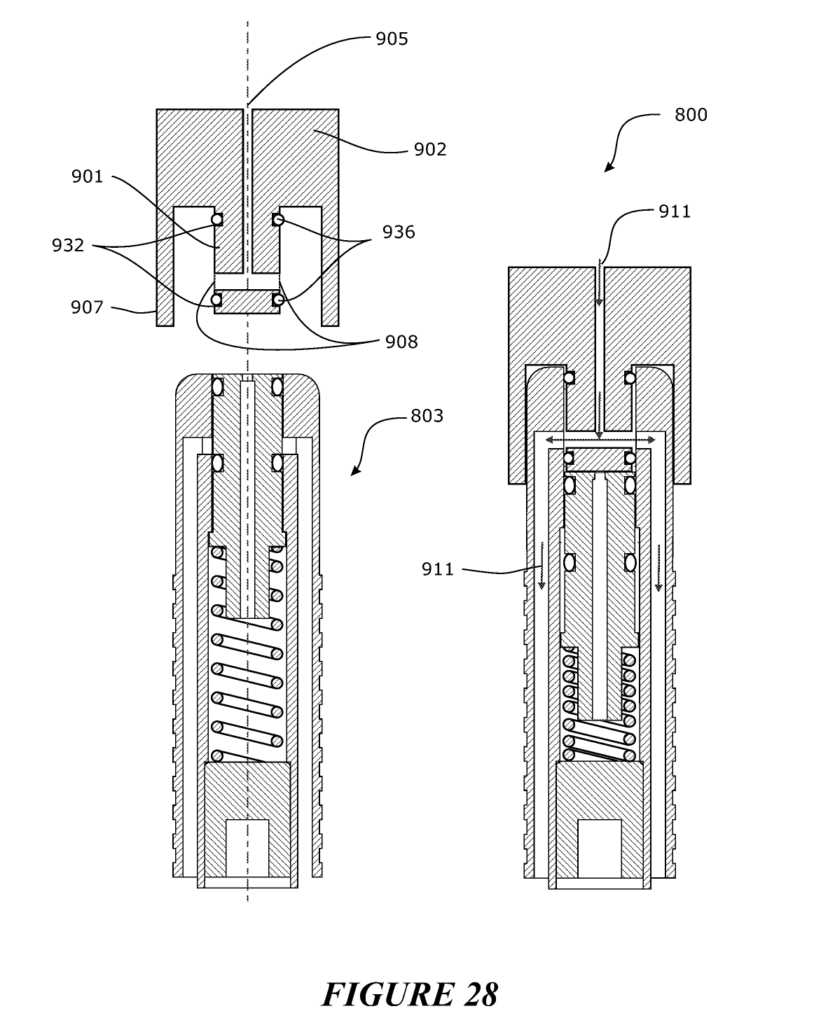

The location of the outlet ports 908 of the air channel 905 on the side walls of the projection 901, are such that when the coupler 902, and air valve assembly 803 are coupled together, the outlet ports 908 of the air coupler 902 correspond with the inlet ports 818 to the air channel 813, of the air valve assembly 803. FIG. 28 illustrates the fitting 803 and coupler 902, coupled together.

When the air coupler 902 and air valve assembly 803 are coupled together, the air channels 813 and 905 are in fluid communication, such that air may be passed from the pressurized air supply (not shown) to the component to be pressurized, as illustrated by arrows 911.

The projection 901 may incorporate one or more grooves 932, on either side of the outlets 908, in order to ensure a seal between the air coupler 902 and air valve assembly 803 when the two parts are coupled together. Preferably these grooves 932 our provided with gaskets or o-rings 936.

It will be appreciated that the pneumatic coupling apparatus 800, shares many common features with the lubrication apparatus 1 described earlier. The main difference between these two embodiments, is the coupler 902 is adapted to directly engage the valve mechanism, to open the fluid pathway between components. This variation enables the pneumatic coupler apparatus 800, to be particularly suited to the delivery of gaseous fluids under pressure.

According to a further variation, the arrangement of the gaskets 936, could be associated with the valve fitting 803, or a combination of the valve fitting 803 and the coupler 902.

Air Coupler with Venting

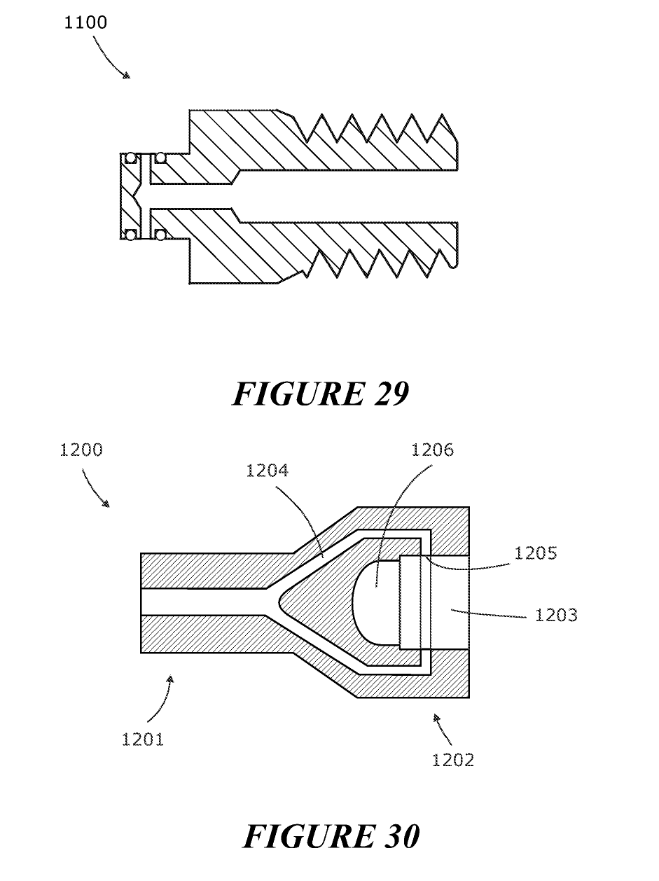

In an alternative embodiment a gases supply apparatus comprised of a nipple or fitting 1100 and fluid coupler 1200 are provided, and described with reference to FIGS. 29 to 32. For convenience, these embodiments described below will be referred to generally as a pneumatic supply apparatus, comprising a pneumatic fitting and a pneumatic coupler, however it will be appreciated that such apparatus may also find use in the transfer of other gases, and/or fluids.

This embodiment is particularly suited to gases supply apparatus, for example for connection to an air supply line. Accordingly, the coupling between the coupler and fitting is more permanent (although separable) and needs to be retained throughout operation.

The nipple 1100 is to be attached to a component to which pressurized gas, for example air, is to be passed, while the air coupler 1200 is to be connected to a supply of pressurized air (not shown). When the nipple 1100 and air coupler 1200 are coupled together, pressurized air is allowed to pass from the pressurized air supply, through the components and into the component which requires pressurized air.

In this embodiment, the nipple 1100 is similar to that described earlier with reference to FIG. 11. However, for this type of pneumatic supply application, there is typically no valve required. Alternatively, a valve may be provided.

Further, it is envisaged that a retaining means (not shown) of any suitable type is employed, to retain the coupler 1200 on the fitting 1100, during use. For example, in the industry there are many known retaining arrangements employed. Any suitable example may be adapted for present purposes, such as clip(s), collars, threaded fittings, hinged clamps etc.

The air coupler 1200 is particularly adapted to high pressure applications that also require high volumes of gases delivery such as jack hammers, sand/grit blasting and mining applications such as drilling etc. In these high-volume applications, there are additional safety considerations.

The air coupler 1200 has a first end 1201 which is to be attached to the pressurized air supply (not shown). The second end 1202 has a receiving portion 1203 formed in it, which is adapted to receive a part of the nipple 1100.

Within the body of the air coupler 1200 are provided one or more air channels 1204. A first end of the air channels 1204 terminate at the connection to the pressurized air supply on the first end 1201. The other end of the one or more air channels 1204 terminate in one or more outlet ports 1205 located on the side wall of the receiving portion 1203.

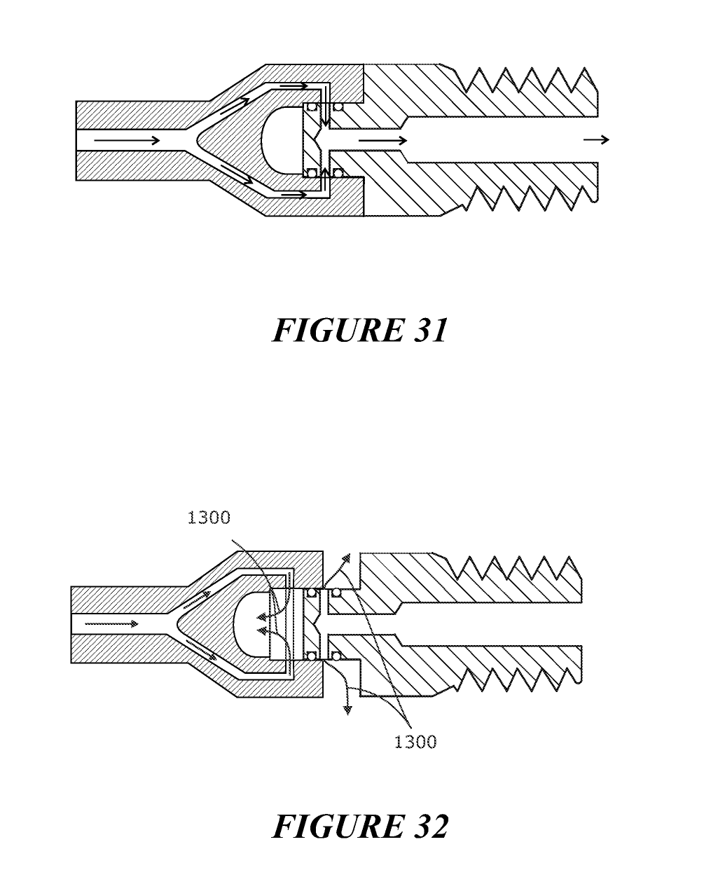

As described with respect to previous embodiments, the outlet ports 1205, provide pressurised fluid into the receiving portion in a direction that is perpendicular (or at least lateral, or transverse) to the coupling direction between nipple 1100 and coupler 1200, as shown in FIG. 31.

The one or more outlet ports 1205 may comprise a circumferentially arranged set of individual outlet ports or may include a continuous groove around the circumference of the receiving portion 1203.

During decoupling of the nipple 1100 and the air coupler 1200, it is possible that there may be residual air under high pressure in the air channel 1204. Additionally, it may be possible that during either the coupling or decoupling of the components, the pressurized air supply may be continuously supplying pressurized air.

As the components couple and/or decouple, the release of this pressurized air may cause forces to be exerted on different surfaces of the components. In particular, the release of large volumes of pressurized air through the outlet ports 1205, when the components are being decoupled, may cause high forces to be exerted on either or both of the end face of the nipple 1100, or the sides of the void 1206. These forces they act to push the nipple 1100 and air coupler 1200 apart, rapidly.

When high pressures are combined with large volumes, this additional decoupling force could cause the components to be violently forced apart from one another. This presents a significant safety risk to an operator of the air supply apparatus, and/or others in the vicinity.

Accordingly, this variation of the air coupler 1200, incorporates safety features to reduce or eliminate the risks due to high volume and high pressure release when coupling, or decoupling. These features provide means for redirecting, or evenly venting high pressure air which is released from the coupler 1200, in opposing directions thereby neutralising the thrust.

The void 1206 is located at the base of the receiving portion 1203. In the preferred embodiment at least one side of the void 1206 is open to the atmosphere, providing a large exhaust pathway for any gases vented from the decoupled or partially decoupled air coupler outlet ports 1205.

It is preferable that any very high pressure gases is intended, have the opportunity to evenly dissipate in a balanced manner. That is, the gases venting forward of the coupler 1200 (as shown by arrows 1300) are not substantially less inhibited than gases venting rearward (towards end 1201, as shown by arrows 1301), in order that the venting gases, can vent evenly, thereby reducing the tendency to propel the coupler 1200 away from the nipple 1100.

Accordingly, it is preferred that the void 1206 is as large as practicable, resulting in the coupler 1200 being skeletal only around void 1206, while it is preferred that the receiving portion 1203 is a complete circumferential ring. In these alternative embodiments, the air channels 1204 pass through the arms of the skeletal portion of coupler 1200.

The back surface of the void 1206 may also be substantially curved or notched so as to direct any high pressure gasses through the one or more openings on the sides of the void.

In an alternate embodiment the void 1206 may comprise a very large volume space with closed sides. The void 1206 in this embodiment would be of a sufficient volume to allow any residual high pressure gases to dissipate pressure but would significantly increase the size of the, thus reducing or eliminating any pressure-induced decoupling of the nipple 1100 and coupler 1200. Closing off the void 1206 from the surroundings would decrease the opportunities for dirt or other contamination to enter the receiving portion 1203, but would significantly increase the size of the coupler.

In a further alternate embodiment, the void 1206 may comprise a space with partially closed sides and large bore pressure relief channels. These pressure relief channels would pass through the body of the air coupler 1200 and vent to the atmosphere.

It is envisaged that the fittings, and couplers described in this specification may be manufactured from a number of different materials, and by any suitable manufacturing technique.

For example, the components are preferably metallic, and most preferably a corrosion resistant metal such as stainless steel. However, other materials such a brass, mild steel, ceramic, polymer or fibre reinforced plastic may also be used. It will be appreciated that the particular application may influence the material choice preferred.

Similarly, the manufacturing technique preferred may also depend on the material selected. For example, the components may be machined in a lathe and/or mill, moulded, cast, 3D printed, or shaped by any other suitable manufacturing technique (or combination thereof).

For purposes of the description hereinafter, the terms “upper”, “lower”, “right”, “left”, “vertical”, “horizontal”, “top”, “bottom”, “lateral”, “transverse”, “longitudinal”, “side”, “front”, “rear” and derivatives thereof shall relate to the invention as it is oriented in the drawing figures. However it is to be understood that the invention may assume various alternative variations, except where expressly specified to the contrary. It is also to be understood that the specific devices illustrated in the attached drawings, and described in the following specification are simply exemplary embodiments of the invention. Hence specific dimensions and other physical characteristics related to the embodiments disclosed herein are not to be considered as limiting.

1-95. (canceled)

96. An apparatus comprising:
a fitting attachable to a device that requires lubrication or the supply of fluid, wherein the fitting includes an insertable section and a fitting channel connecting with one or more entry ports opening on to at least one circumferential groove in an external side of the insertable section of the fitting, and a second exit through an end of the fitting distal to the insertable section, and wherein the fitting further includes at least one sealing groove on either side of the circumferential groove and provided with a continuous flexible seal;
a complementary coupler connectable to a fluid reservoir, wherein the coupler comprises a body and a hole including an inside wall, the hole being dimensioned to be a close fit over the insertable section of the fitting, wherein the coupler further includes one or more feed channels, wherein each feed channel having one or more feed channel exits through the inside wall of the hole; and
such that when the insertable section is in a delivery position in the hole, a fluid can be transferred under pressure from the fluid reservoir via the feed channel to the fitting channel, wherein the fluid is able to leave the feed channel through at least one feed channel exit and pass into the fitting channel via at least one of the entry port.

97. The apparatus according to claim 96, wherein the circumferential groove is provided with further continuous flexible seal.

98. The apparatus according to claim 96, wherein the continuous flexible seal is a O-ring or gasket.

99. The apparatus according to claim 96, wherein the hole of the coupler includes at least one vent hole providing a pathway for an unwanted fluid.

100. The apparatus according to claim 96, wherein the sealing groove is a continuous flexible seal which is dimensioned to form a fluid tight seal against the inside side wall of the hole of the coupler.

101. The apparatus according to claim 96, wherein the hole of the coupler defines an axis of insertion, and the feed channel exits are located in a side wall of the hole and are adapted to expel fluid in a direction lateral with respect to the axis of insertion.

102. The apparatus according to claim 96, wherein the fitting channel includes at least one movable sealing means as a resiliently mounted spherical ball.

103. The apparatus according to claim 96, wherein the coupler is generally an elongate body defining a coupler axis, wherein the fluid flow through the body is generally parallel to the coupler axis, and the fitting is a elongate body defining a fitting axis, wherein the flow through the fitting body is generally parallel to the fitting axis, and wherein during coupling, the coupler axis is at an angle to the fitting axis.

104. The apparatus according to claim 103, wherein the angle is 90°.

105. The apparatus according to claim 96, wherein the apparatus has no additional sealing requirements, and the hole in the coupler, and the insertable section of the fitting, being dimensioned to form a fluid tight seal when engaged.

106. An apparatus comprising:
a fitting attachable to a device that requires lubrication or the supply of fluid, wherein the fitting includes an insertable section and a fitting channel connecting with one or more entry ports opening on to at least one circumferential groove in an external side of the insertable section of the fitting, and a second exit through an end of the fitting distal to the insertable section, and wherein the fitting further includes at least one sealing groove on either side of the circumferential groove with the sealing groove and circumferential groove being provided with a continuous flexible seal;
a complementary coupler connectable to a fluid reservoir wherein the coupler comprises a body and a hole including an inside wall, the hole being dimensioned to be a close fit over the insertable section of the fitting and includes at least one vent hole adapted to allow unwanted fluid to escape there from, wherein the coupler further includes one or more feed channels, wherein each feed channel having one or more feed channel exits through the inside wall of the hole and the hole of the coupler defines an axis of insertion, and the feed channel exits are at an angle with respect to the axis of insertion; and
such that when the insertable section is in a delivery position in the hole, a fluid can be transferred under pressure from the fluid reservoir via the feed channel, to the fitting channel, wherein the fluid is able to leave the feed channel through at least one feed channel exit, and pass into the fitting channel via at least one the entry port.

107. The apparatus according to claim 106, wherein the continuous flexible seal is a O-ring or gasket.

108. The apparatus according to claim 106, wherein the sealing groove is a continuous flexible seal which is dimensioned to form a fluid tight seal against the inside side wall of the hole of the coupler.

109. The apparatus according to claim 106, wherein the fitting channel includes at least one movable sealing means as a resiliently mounted spherical ball.

110. The apparatus according to claim 106, wherein the coupler is generally an elongate body defining a coupler axis, wherein fluid flow through the body is generally parallel to the coupler axis, and the fitting is a generally elongate body defining a fitting axis, wherein flow through the fitting body is generally parallel to the fitting axis, and wherein during coupling, the coupler axis is at an angle to the fitting axis.

111. The apparatus according to claim 110, wherein the angle is 90°.

112. The apparatus according to claim 106, wherein the fitting channel includes a first channel diameter portion leading to a second channel diameter portion, wherein the first diameter portions less than the second portion, defining a valve seat, and the spherical ball is located in the second diameter channel portion to biasedly seal against the valve seat.

113. The apparatus according to claim 106, wherein the one or more feed channel exits open into one or more grooves extending around the inside side wall of the coupler.

114. The apparatus according to claim 106, wherein the end of the coupler in connection with the fluid reservoir is hexagonal in shape.

115. An apparatus for supply of gases comprising:
a fitting assembly for providing gases from a gases supply, to a component to be pressurized or inflated, wherein the fitting comprises of an elongate valve body having a first end, and a second end, and being at least partially hollow to define a valve body wall, a valve core slidably located within the hollow valve body, wherein the valve body includes at least one passageway within the valve body wall, and wherein the passageway begins at an entry port on an internal face of the hollow of the valve body, and at least an initial portion of the passageway extends transverse to the valve body, and terminates at an exit located a distance from the first end of the valve body, wherein the valve core, when in a first position blocks the entry port, and when in a second position opens the entry port; and
a coupler to couple with a fitting comprising an elongate body having a first inlet end, and a second outlet end, wherein the inlet end is adapted to receive gas from the gaseous supply, and the outlet end is adapted to couple with a fitting, a receiving recess in the outlet end of the body defining an inner projection, and surrounding the inner projection, a gas supply passageway extending from the inlet through the projection, and terminating in at least one exit port in an outer wall of the projection, wherein the exit port is adapted to expel gas in a direction transverse to an axis of the body.
